(19) United States
(12) Patent Application Publication
(10) Pub. No.: US 2009/0122207 A1
(43) Pub. Date: May 14, 2009

(54) Image Display Apparatus, Image Display Monitor, and Television Receiver

(76) Inventors: Akihiko Inoue, Kyoto (JP); Takeshi Kumakura, Nara (JP); Mitsuhiro Shigeta, Kyoto (JP); Tai Shiraishi, Nara (JP)

Correspondence Address: HARNESS, DICKEY & PIERCE, P.L.C., P.O. BOX 8910, RESTON, VA, 20195, US

(21) Appl. No.: 11/883,941

(22) PCT Filed: Mar. 15, 2006
(86) PCT No.: PCT/JP06/05172

§ 371 Date: Aug. 8, 2007

(30) Foreign Application Priority Data
Mar. 18, 2005 (JP) 2005-080556

(51) Int. Cl. H04N 5/66; H04N 5/44

(52) U.S. Cl. 348/739; 348/725; 348/E05.133; 348/E05.096

(57) ABSTRACT

In the first display mode, a first tone converting circuit and a second tone converting circuit of a control LSI divide one frame period of an input image signal into a plurality of sub-frame periods to perform output to a display panel, thus realizing image display performed by time-division driving (pseudo-impulse driving). In the second display mode, the control LSI directly outputs an input image signal to the display panel, thus realizing image display performed by hold driving. In at least one embodiment, switching between the first display mode and the second display mode is performed by changing output of an output data selector according to a mode switching signal. This realizes an image display apparatus which effectively obtains the effect of suppressing blurring of a moving image and alleviates the problem of flickers caused by pseudo-impulse driving.

### TECHNICAL FIELD

The present invention relates to an image display apparatus including a hold-type display element therein, such as a liquid crystal display element or an EL (Electro Luminescence) display element.

### BACKGROUND ART

In recent years, in addition to CRT (cathode-ray tube) display apparatuses, various kinds of displays, such as liquid crystal display apparatuses, plasma display apparatuses, and organic electroluminescent display apparatuses have been developed and commercialized.

In display apparatuses, such as CRT display apparatuses, which perform impulse-type display (display carried out during a light-emission period only), pixels carry out black display during a non-selected period. Meanwhile, hold-type display apparatuses (which holds an image of a previous frame until a new image is written) such as liquid crystal display apparatuses and organic electroluminescent display apparatuses, display data previously written is held by pixels during a non-selected period (normal display of the hold-type display apparatus).

The normal display of the hold-type display apparatus gives rise to the problem that blurring occurs in a moving image in displaying a moving image. The problem results from the pixels of the hold-type display apparatus holding display data even during a non-selected period. The problem is not solved by increasing a response speed of the pixels.

Some hold-type display apparatuses perform time-division driving to prevent blurring of a moving image. It should be noted that time-division driving is a driving method in which one vertical period (one frame) is divided into a plurality of sub-frames so that a signal is written on each pixel for a plurality of times.

That is, even the hold-type display apparatus can perform pseudo-impulse display by performing time-division driving to carry out display with low luminance (display close to black display) in at least one of the sub-frames. This is effective in preventing blurring of a moving image.

Time-division driving of a liquid crystal display apparatus is disclosed in Patent document 1, for example.

[Patent Document 1]

Japanese Unexamined Patent Publication No. 296841/2001 (Tokukai 2001-296841; published on Oct. 26, 2001)

[Patent Document 2]

Japanese Unexamined Patent Publication No. 184034/2001 (Tokukai 2001-184034; published on Jul. 6, 2001)

[Patent Document 3]

Japanese Unexamined Patent Publication No. 262846/2003 (Tokukai 2003-262846; published on Sep. 19, 2003)

### DISCLOSURE OF INVENTION

However, when a display apparatus including a hold-type display element performs the above-mentioned pseudo-impulse driving for enhancement of moving image display performance, flickers are likely to occur. This problem is also associated with recent trend toward display apparatuses with high luminance and large-sized screen. Noticeable flickers occur particularly in case where a frame frequency is low, luminance is high, or other cases, and cause eyestrain in user's eyes.

The present invention has been attained in view of the above problem, and an object of the present invention is to realize an image display apparatus which effectively obtains the effect of suppressing blurring of a moving image by pseudo-impulse driving and alleviates the problem of flickers caused by pseudo-impulse driving.

In order to solve the above problem, an image display apparatus of the present invention has a first display mode and a second display mode, the first display mode being a mode in which one frame period is divided into a plurality of sub-frame periods, and luminance of the one frame period based on an input image signal is distributed to the sub-frames so that the luminance of the one frame period is reproduced by the sub-frames for image display, the second display mode being a mode in which image display during one frame period is performed at a single luminance level so that luminance of the one frame period based on an input image signal is reproduced, wherein said image display apparatus switches between the first display mode and the second display mode to perform image display.

According to the above arrangement, the image display apparatus has the first display mode and the second display mode. In the first display mode, one frame period is divided into a plurality of sub-frame periods, and luminance of the one frame period based on an input image signal is distributed to the sub-frames so that the luminance of the one frame period is reproduced by the sub-frames for image display (so-called time-division driving display). In the second display mode, image display during one frame period is performed at a single luminance level so that luminance of the one frame period based on an input image signal is reproduced (so-called hold driving display). In the image display apparatus, it is possible to switch between the first display mode and the second display mode.

With this arrangement, in order to suppress blurring of a moving image, a display image signal can be generated by time-division driving, which is highly effective in suppressing blurring of a moving image (display in the first display mode). In order to suppress flickers, a display image signal can be generated by hold driving, in which flickers are less likely to occur (display in the second display mode). This makes it possible to effectively obtain the effect of suppressing blurring of a moving image by pseudo-impulse driving and to alleviate the problem of flickers caused by pseudo-impulse driving.

In order to solve the above problem, another image display apparatus of the present invention includes: first signal generating means that divides one frame period into a plurality of sub-frame periods, and generates a display image signal such that luminance of the one frame period based on an input image signal is distributed to the sub-frames so that the luminance of the one frame period is reproduced by a sum total of time integral values of luminance of the respective sub-frames; and second signal generating means that generates a display image signal such that the one frame period is regarded as a single frame period so that a predetermined luminance is reproduced during the one frame period, wherein switching between output of the first signal generating means and output of the second signal generating means is performed so that the display image signal is outputted to a display section.

Further, the image display apparatus can be arranged so as to further include: switching means that switches between output of the first signal generating means and output of the second signal generating means to output the display image signal to the display section.

In the image display apparatus which performs time-division driving, luminance is distributed to the sub-frames so that luminance characteristics during one frame period based on an input image signal are realized by time integral values of luminance of the respective sub-frames. Time-division driving display becomes pseudo-impulse display when a sub-frame with high luminance and a sub-frame with low luminance are caused by the luminance distribution to the sub-frames as described above, thus exerting the effect on blurring of a moving image. However, the time-division driving produces the effect of suppressing blurring of a moving image, but gives rise to the problem that flickers are likely to occur.

According to the above arrangement, the image display apparatus has the first display mode in which image display is performed by time-division driving and the second display mode in which image display is performed by hold driving. In addition, the image display apparatus includes the first signal generating means that generates a display image signal in performing image display in the first display mode and the second signal generating means that generates a display image signal in performing image display in the second display mode, and can switch between the first signal generating means and the second signal generating means for use. That is, switching between the first display mode in which image display is performed by time-division driving and the second display mode in which image display is performed by hold driving is performed.

With this arrangement, in order to suppress blurring of a moving image, a display image signal can be generated by time-division driving, which is highly effective in suppressing blurring of a moving image (display in the first display mode). In order to suppress flickers, a display image signal can be generated by hold driving, in which flickers are less likely to occur (display in the second display mode). This makes it possible to effectively obtain the effect of suppressing blurring of a moving image by pseudo-impulse driving and to alleviate the problem of flickers caused by pseudo-impulse driving.

### BRIEF DESCRIPTION OF DRAWINGS

FIG. 1 illustrates an embodiment of the present invention and is a block diagram schematically illustrating the structure of a control LSI of First Embodiment.

FIG. 2 is a block diagram schematically illustrating the structure of an image display apparatus of First Embodiment.

FIG. 3 is a view illustrating luminance distribution in a first display mode of the image display apparatus.

FIG. 4 is a view illustrating luminance distribution in a second display mode of the image display apparatus.

FIG. 5 is a view illustrating operations in the first display mode of the image display apparatus.

FIG. 6 is a view illustrating operations in the second display mode of the image display apparatus.

FIG. 7 is a block diagram schematically illustrating the structure of an image display apparatus of Second Embodiment.

FIG. 8 is a block diagram schematically illustrating the structure of a control LSI of Second Embodiment.

FIG. 9 is a block diagram schematically illustrating the structure of a control LSI of Third Embodiment.

FIG. 10 is a block diagram schematically illustrating the structure of a control LSI of Fourth Embodiment.

FIG. 11 is a block diagram schematically illustrating the structure of an image display apparatus of Fifth Embodiment.

FIG. 12 is a block diagram schematically illustrating the structure of a control LSI of Seventh Embodiment.

FIG. 13 is a view illustrating an example of a display screen which is divided into a plurality of block areas.

FIG. 14 is a block diagram schematically illustrating the structure of an area-by-area determining circuit of Seventh Embodiment.

FIG. 15(a) is a view illustrating an example of a block area which is determined as a moving image area.

FIG. 15(b) is a view illustrating an example of a block area which is determined as a still image area.

FIG. 16 is a view illustrating a modified example of a method for determining a moving image area and a still image area.

FIG. 17 is a block diagram schematically illustrating the structure of an area-by-area determining circuit of Seventh Embodiment.

### EXPLANATION OF REFERENCE NUMERALS

1, 2, 3 image display apparatus
10 display panel (display section)
20 frame memory (first signal generating means)
30, 60, 70, 80, 90 control LSI (first signal generating means, second signal generating means)
31 line buffer (first signal generating means)
32 timing controller
33 frame memory data selector (first signal generating means)
34 first tone converting circuit (first signal generating means)
35 second tone converting circuit (first signal generating means)
36 tone conversion data selector (first signal generating means)
37 output data selector (switching means)
50 mode selector switch (switching means)
51 image source selector switch (image source determining means, switching means)
61 moving/still image determining circuit (determining means, moving/ still image determining means, switching means)
71 luminance measuring circuit (determining means, luminance measuring means, switching means)
81 frame frequency measuring circuit (determining means, frame frequency measuring means, switching means)
91 area-by-area determining circuit (determining means, moving/still image determining means, switching means)
91′ area-by-area determining circuit (determining means, luminance measuring means, switching means)

### BEST MODE FOR CARRYING OUT THE INVENTION

### First Embodiment

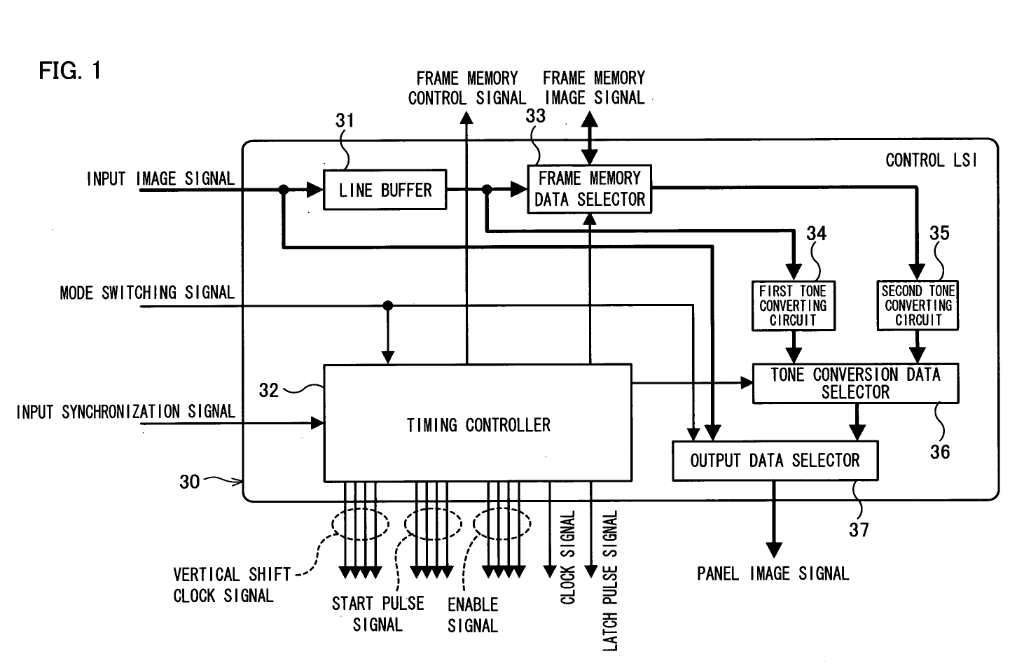

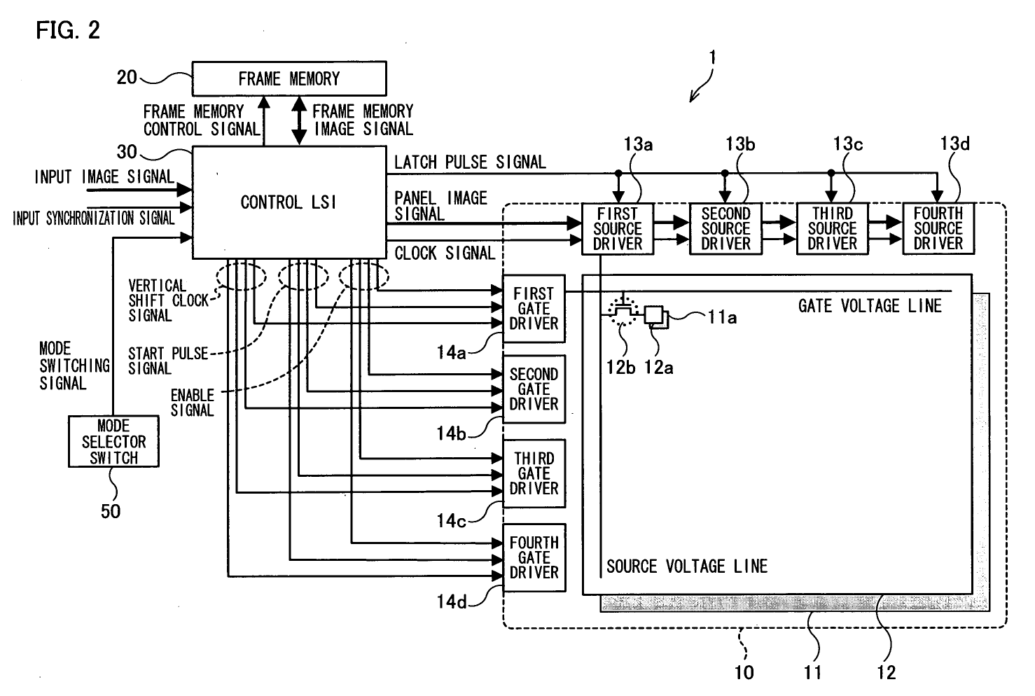

The following will describe an embodiment of the present invention with reference to FIGS. 1 through 6. To begin with, the structure of an image display apparatus of First Embodiment is schematized below with reference to FIG. 2. In FIG. 2, an image display apparatus 1 includes a display panel 10, a frame memory 20, a control LSI 30, and a mode selector switch 50.

The display panel 10 constitutes image display means and has a display element array 11, a TFT substrate 12, source drivers 13a through 13d, and gate drivers 14a through 14d. On the display element array 11, a plurality of display elements 11a (pixel sections) made of liquid crystal material or organic electroluminescent material are arranged in a matrix manner.

In a display area of the TFT substrate 12, respective pixel electrodes 12a and respective TFTs 12b are arranged in a matrix manner so as to correspond to the display elements 11a. The pixel electrodes 12a drive the display elements 11a. The TFTs 12b serve as switching elements that turn on/off supply of electric charges (display voltage) to the pixel electrodes 12a. Around the display element array 11 and the display area of the TFT substrate 12, are arranged source drivers and gate drivers for performing display driving of the pixel electrodes 12a and the display elements 11a via the respective TFTs 12b. As an example of the arrangement of the source drivers, a first source driver 13a, a second source driver 13b, a third source driver 13c, and a fourth source driver 13d are cascaded. As an example of the arrangement of the gate drivers, a first gate driver 14a, a second gate driver 14b, a third gate driver 14c, and a fourth gate driver 14d are cascaded.

In the display area of the TFT substrate 12, a plurality of source voltage lines and a plurality of gate voltage lines are provided so as to cross each other. The source voltage lines are connected to the respective source drivers so that the source drivers apply source voltages (display voltages) to the source voltage lines. The gate voltage lines are connected to the respective gate drivers so that the gate drivers apply the gate voltages (scanning signal voltages) to the gate voltage lines. Near each intersection of the source voltage line and the gate voltage line, are provided the pixel electrode 12a and the TFT 12b.

A gate electrode of the TFT 12b is connected to the corresponding gate voltage line (gate voltage line at the intersection). A source electrode of the TFT 12b is connected to the corresponding source voltage line (source voltage line at the intersection). A drain electrode of the TFT 12b is connected to the pixel electrode 12a.

The frame memory 20 accumulates image signals for display on the display panel 10 which signals correspond to one frame. The control LSI 30 is display control means that controls the sections. The mode selector switch 50 outputs a mode switching signal to the control LSI 30 according to user's operation so that a display mode can be changed according to user's instruction.

The following will describe a basic image display method in the image display apparatus 1 arranged as described above.

First of all, panel image signals (display image signals) for display on pixel sections corresponding to one horizontal line are successively transmitted from the control LSI 30 to the first source driver 13a in sync with clock signals. Since the first through fourth source drivers 13a through 13d are cascaded as illustrated in FIG. 2, the panel image signals for pixels of one horizontal line are temporally held in the first through fourth source drivers 13a through 13d by pulses of the clock signals for pixels of one horizontal line. With this state, when latch pulse signals are outputted from the control LSI 30 to the first through fourth source drivers 13a through 13d, display voltage levels corresponding to the image signals of each of the pixel sections are outputted from each of the source drivers 13a through 13d to the corresponding source voltage lines for the pixels of one horizontal line.

Further, the control LSI 30 outputs control signals, i.e. an enable signal, a start pulse signal, and a vertical shift clock signal to each of the gate drivers 14a through 14d. While the enable signal is at low level, the gate voltage line is in off-state. When the enable signal is at high level and the start pulse signal is supplied to the gate driver, a first gate voltage line of the corresponding gate driver becomes in on-state on a rising edge of the vertical shift clock signal. When the enable signal is at high level and the start pulse signal is not supplied to the gate driver, a gate voltage line subsequent to the gate voltage line that was previously in on-state becomes in on-state on a rising edge of the vertical shift clock signal.

While one gate voltage line is in on-state during a period when a display voltage for pixels of one horizontal line is outputted to the source voltage line, the TFTs 12b for pixels of one horizontal line which TFTs are connected to the gate voltage line become in on-state. With this, electric charges (display voltage) are supplied from each of the source voltage lines to each of the pixel electrodes 12a for pixels of one horizontal line. This changes the state of the display elements 11a, and image display is carried out. When the display control as described above is repeated for each horizontal line, an image is displayed on the entire display screen.

An object of the image display apparatus 1 according to First Embodiment is to effectively obtain the effect of suppressing blurring of a moving image by pseudo-impulse driving and to alleviate the problem of flickers caused by pseudo-impulse driving. In order to achieve the object, the image display apparatus 1 has the feature that a display mode is changed according to the nature of an image to be displayed. The feature is described below in detail.

In the image display apparatus 1, a display mode is changed according to user's instruction entered by means of the mode selector switch 50, as an exemplary arrangement. That is, when a user operates the mode selector switch 50 to change a display mode, a mode switching signal is supplied from the mode selector switch 50 to the control LSI 30. This allows the control LSI 30 to perform control for change of a display mode.

For pseudo-impulse display which suppresses blurring of a moving image, the image display apparatus 1 has a first display mode in which time-division driving is performed. That is, in the first display mode, the display panel 10 is driven with one frame divided into a plurality of sub-frames. Further, the image display apparatus 1 has a second display mode in which a normal hold driving is performed.

First of all, the first display mode in which time-division driving is performed is described. In the first display mode in which time-division driving is performed, luminance is distributed to the sub-frames so that luminance characteristics during one frame period based on an input image signal are reproduced by time integral values of luminance of the sub-frames. Time-division driving display becomes pseudo-impulse display when a sub-frame with high luminance and a sub-frame with low luminance are caused by the luminance distribution to the sub-frames as described above, thus exerting the effect on blurring of a moving image.

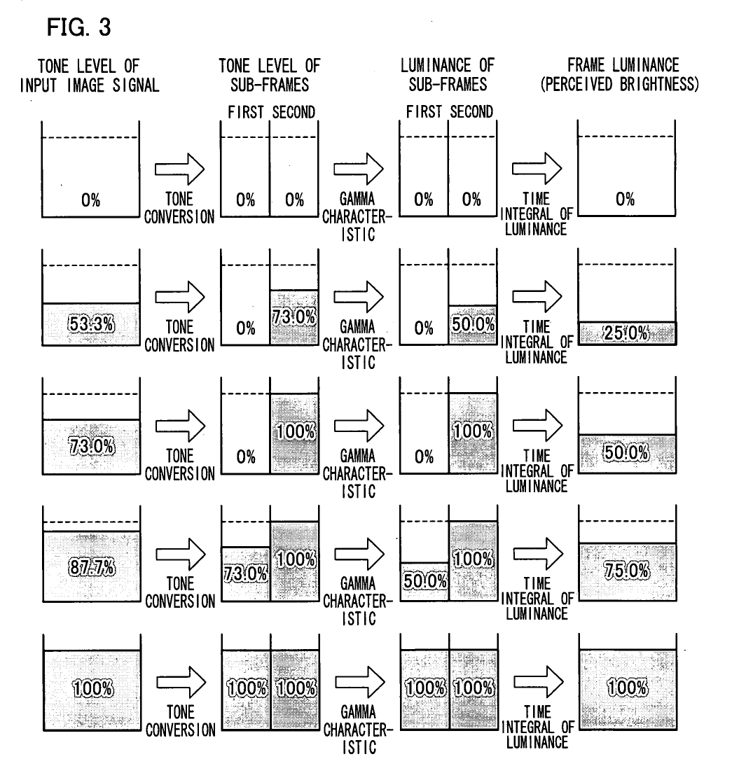

Table 1 shows an example of luminance distribution ratios of the sub-frames in the first display mode. It should be noted that Table 1 below assumes that the sub-frames are two sub-frames, i.e. a first sub-frame and a second sub-frame, and a time ratio of the sub-frames is 1:1. FIG. 3 illustrates luminance distribution based on the distribution ratios shown in Table 1.

TABLE 1

| Tone level | Sub-frame | | Sub-frame | | Difference in | Frame |
|---|---|---|---|---|---|---|
| of input | tone level | | luminance | | luminance | luminance |
| image | First | Second | First | Second | between | (Integral |
| signal | sub-frame | sub-frame | sub-frame | sub-frame | sub-frames | luminance) |
| 0.0 | 0.0 | 0.0 | 0.0 | 0.0 | 0.0 | 0.0 |
| 53.3 | 0.0 | 73.0 | 0.0 | 50.0 | 50.0 | 25.0 |
| 73.0 | 0.0 | 100.0 | 0.0 | 100.0 | 100.0 | 50.0 |
| 87.7 | 73.0 | 100.0 | 50.0 | 100.0 | 49.9 | 75.0 |
| 100.0 | 100.0 | 100.0 | 100.0 | 100.0 | 0.0 | 100.0 |

Unit: percentage (%)

FIG. 3 illustrates the first display mode that places importance on moving image display performance, and illustrates examples of luminance distribution to the sub-frames in the cases where a tone level of the input image signal is 0% (0% frame luminance), 53.3% (25% frame luminance), 73.0% (50% frame luminance), 87.7% (75% frame luminance), and 100% (100% frame luminance). It should be noted that a relation between frame luminance and tone level of the input image signal satisfies Equation (1) below. In Equation (1), it is known that display characteristics are close to actual display characteristics when γ (gamma characteristic) is 2.2.

$$\begin{matrix}Frame luminance = {( Tone level of input image signal )}^{γ} \\ = ( {( Tone level of first sub \text{-} frame )}^{γ} + \\ {( Tone level of second sub \text{-} frame )}^{γ} ) / 2\end{matrix} \qquad ( 1 )$$

In the first display mode shown in Table 1 and FIG. 3, when the frame luminance is in a range from 0% to 50%, luminance of one sub-frame (first sub-frame in this case) is fixed to a lowest luminance (0%), and the other sub-frame (second sub-frame in this case) is varied. Further, when the frame luminance is in a range from 50% to 100%, luminance of one sub-frame (second sub-frame in this case) is fixed to a highest luminance (100%), and the other sub-frame (first sub-frame in this case) is varied.

The luminance distribution ratios in the first display mode shown in Table 1 and FIG. 3 are set so that difference in luminance between the sub-frames is the largest in each of the tone levels, are the most effective in preventing blurring of a moving image. However, in the present invention, luminance distribution ratios of sub-frames in the first display mode in which time-division driving is performed are not limited to the above-mentioned distribution ratios.

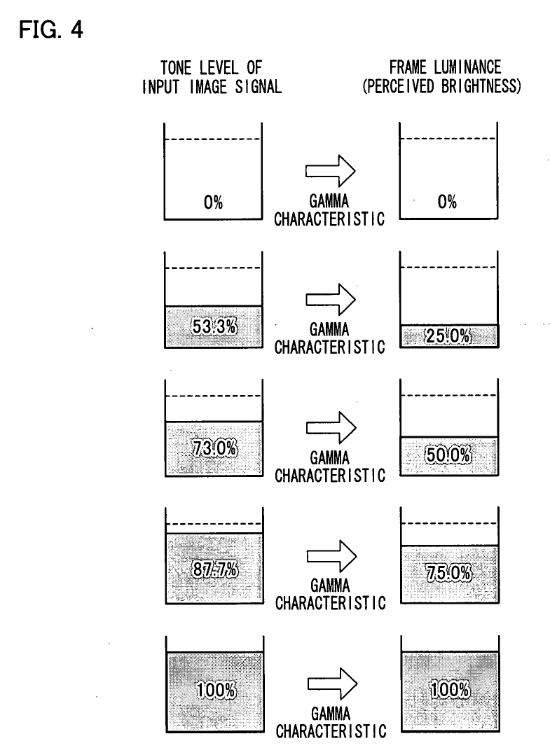

The first display mode in which time-division driving is performed produces the effect of suppressing blurring of a moving image, but gives rise to the problem that flickers are likely to occur. In view of this, the image display apparatus 1 has the second display mode as well as the first display mode that is effective in suppressing blurring of a moving image. In the second display mode, normal hold driving is performed in consideration of the suppression of the occurrence of flickers. In the second display mode, since luminance distribution to sub-frames, i.e. time-division driving is not performed, a given frame luminance is given with respect to each of the tone levels of an input image signal, as shown in Table 2 below and FIG. 4. It should be noted that a relation between frame luminance and tone level of an input image signal satisfies Equation (2) below. In Equation (2), display characteristics are also close to actual display characteristics when γ (gamma characteristic) is 2.2.

TABLE 2

| Tone level of | Frame luminance |
|---|---|
| input image signal | (Integrated luminance) |
| 0.0 | 0.0 |
| 53.3 | 25.0 |
| 73.0 | 50.0 |
| 87.7 | 75.0 |
| 100.0 | 100.0 |

Unit: percentage (%)

Frame luminance=(Tone level of input image signal)^{γ} (2)

Next, the structure of the control LSI 30 for performing control for switching between the first display mode and the second display mode with reference to FIG. 1.

As illustrated in FIG. 1, the control LSI 30 includes a line buffer 31, a timing controller 32, a frame memory data selector 33, a first tone converting circuit 34, a second tone converting circuit 35, a tone conversion data selector 36, and an output data selector 37.

The line buffer 31 receives incoming input image signals of one horizontal line at a time and temporarily holds the signals therein. The line buffer 31 separately includes a reception port and a transmission port, so that the line buffer 31 can perform reception and transmission of the input image signals at the same time.

The timing controller 32 controls the frame memory data selector 33 so as to alternately switch between a timing when the frame memory data selector 33 transmits data to the frame memory 20 and a timing when the frame memory data selector 33 reads out data from the frame memory 20. Further, the timing controller 32 controls the tone conversion data selector 36 so as to alternately select a timing when the tone conversion data selector 36 receives output from the first tone converting circuit 34 and a timing when the tone conversion data selector 36 receives output from the second tone converting circuit 35. In other words, the timing controller 32 controls the tone conversion data selector 36 so as to switch between a first sub-frame period and a second sub-frame period. Further, the timing controller 32 outputs, at a predetermined timing, a clock signal, a latch pulse signal, an enable signal, a start pulse signal, and a vertical shift clock signal all of which are generated on the basis of an input synchronization signal.

Under control of the timing controller 32, the frame memory data selector 33 alternately selects the following two operations. One operation is the one for data transmission of an input image signal, which is held in the line buffer 31, for one horizontal line at a time to the frame memory 20. The other operation is the one for readout of a previous frame image signal, which was supplied and stored in the frame memory 20, for one horizontal line at a time. Further, the frame memory data selector 33 reads out image data from the frame memory 20 and then transmits the read image data to the second tone converting circuit 35.

The first tone converting circuit 34 receives the input image signal supplied from the line buffer 31, and converts a tone level of the received input image signal into a tone level of the first sub-frame for time-division driving to output an image signal. In performing such a tone level conversion, the first tone converting circuit 34 refers to a LUT (Look-Up Table) that stores therein a tone level of the input image signal and a tone level of the first sub-frame in such a manner that they are associated with each other. In FIG. 1, the LUT is stored in the first tone converting circuit 34.

The second tone converting circuit 35 receives the input image signal supplied from the frame memory 20 via the frame memory data selector 33, and converts a tone level of the received input image signal into a tone level of the second sub-frame for time-division driving to output an image signal. In performing such a tone level conversion, the second tone converting circuit 35 refers to a LUT (Look-Up Table) that stores therein a tone level of the input image signal and a tone level of the second sub-frame in such a manner that they are associated with each other. In FIG. 1, the LUT is stored in the second tone converting circuit 35.

It should be noted that the first tone converting circuit 34 and the second tone converting circuit 35 are not limited to the circuits which read a tone level of each sub-frame corresponding to a tone level of the input image signal from the LUT for tone level conversion. For example, the first tone converting circuit 34 and the second tone converting circuit 35 may obtain a tone level of each sub-frame corresponding to a tone level of the input image signal by performing operation on the basis of a computational equation.

Under control of the timing controller 32, the tone conversion data selector 36 switches between an image signal outputted from the first tone converting circuit 34 and an image signal outputted from the second tone converting circuit 35 to output the image signal to the output data selector 37. In other words, in the first sub-frame period, the tone conversion data selector 36 outputs the image signal outputted from the first tone converting circuit 34 to the output data selector 37. In the second sub-frame period, the tone conversion data selector 36 outputs the image signal outputted from the second tone converting circuit 35 to the output data selector 37.

Also, the output data selector 37 directly receives the input image signal and the mode switching signal, both of which are supplied to the control LSI 30, and also receives an output signal from the tone conversion data selector 36. According to the mode switching signal, the output data selector 37 outputs as the panel image signal one of the input image signal and the signal supplied from the tone conversion data selector 36. In other words, in a case where the mode switching signal indicates the first display mode (time-division driving), the output data selector 37 outputs as the panel image signal the signal supplied from the tone conversion data selector 36. On the other hand, in a case where the mode switching signal indicates the second display mode (hold driving), the output data selector 37 directly outputs as the panel image signal the input image signal.

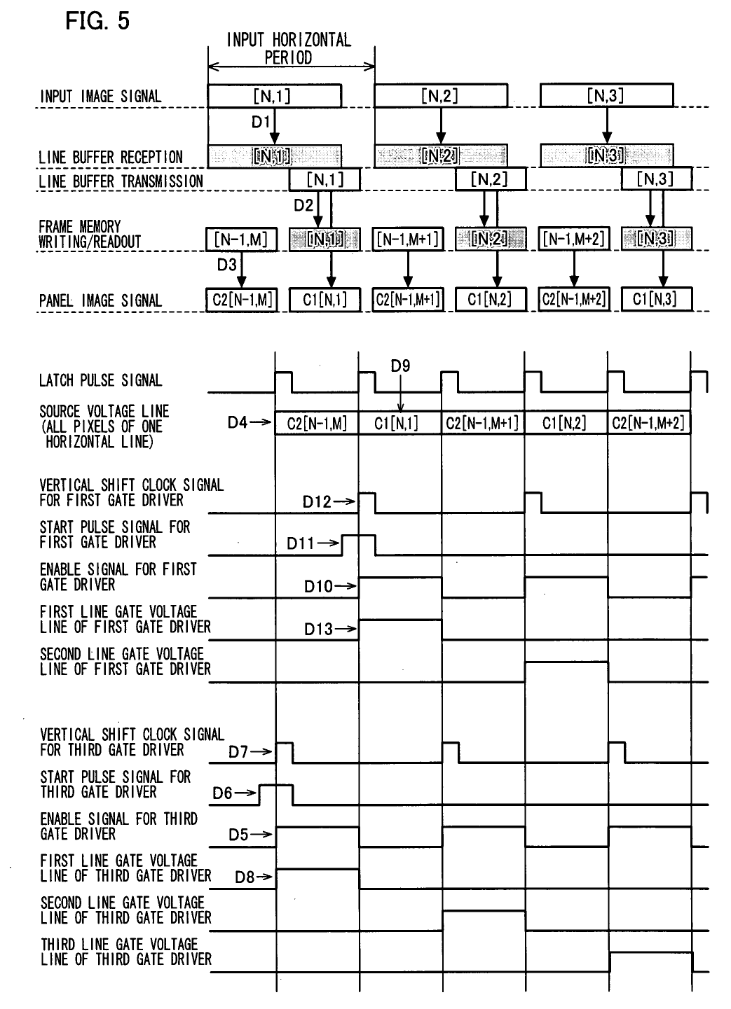

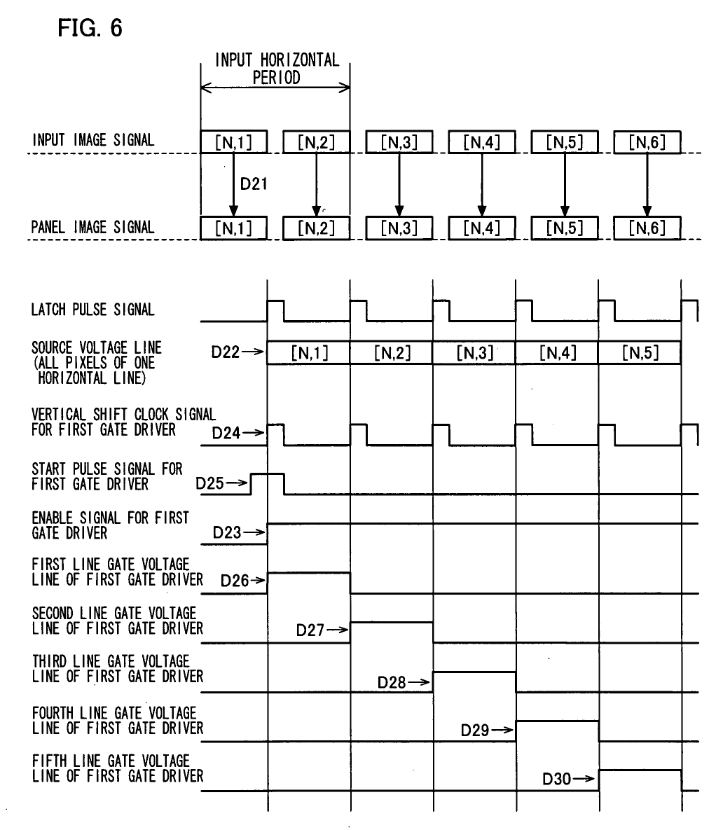

Here, operations of the image display apparatus 1 including the control LSI 30 arranged as described above are described with reference to FIGS. 5 and 6. FIG. 5 is a view illustrating a flow of an image signal for each horizontal period in the first display mode of the image display apparatus, i.e. at the time-division driving. FIG. 6 is a view illustrating a flow of an image signal for each horizontal period in the second display mode of the image display apparatus, i.e. at the hold driving.

Note that in FIGS. 5 and 6, characters in parentheses [ ] indicate transmission period of image signals of one horizontal line. For example, [N,1] indicates that an input image signal supplied to a first horizontal line of a Nth frame is being transmitted. An Mth line indicates a middle line of the screen. In First Embodiment, the Mth line is a horizontal line which is driven by a first gate voltage line of the third gate driver 14c.

In FIG. 5, C1 indicates that a transmitted image signal is a signal into which an input image signal for a frame and a horizontal line that are indicated in parentheses [ ] following C1 is converted as a source by the first tone converting circuit 34. C2 indicates that a transmitted image signal is a signal into which an input image signal for a frame and a horizontal line that are indicated in parentheses [ ] following C2 is converted as a source by the second tone converting circuit 35.

First of all, the following will describe operations of the image display apparatus 1 in the first display mode with reference to FIG. 5. FIG. 5 shows a period during which image input signals of first to third lines of an Nth frame are supplied.

As indicated by an arrow D1 in FIG. 5, an incoming input image signal is received by the line buffer 31. Then, as indicated by an arrow D2 in FIG. 5, the line buffer 31 performs writing to the frame memory 20 via the frame memory data selector 33 and performs transmission to the first tone converting circuit 34 in the middle of reception of an image signal of one line. The first tone converting circuit 34 outputs a converted image signal as the panel image signal.

Further, as indicated by an arrow D3, writing to the frame memory 20 and reading from the frame memory 20 are performed alternately. At the reading from the frame memory 20, an image signal for a horizontal line that is previous by half frame to a line of the written image signal is read on a line by line basis. The image signal having been read out from the frame memory 20 is transmitted to the second tone converting circuit 35 via the frame memory data selector 33, and the second tone converting circuit 35 outputs a converted image signal as the panel image signal via the tone conversion data selector 36 and the output data selector 37.

Further, when latch pulse signals are supplied after the panel image signals of one horizontal line, which signals are outputted from the control LSI 30, are transmitted to the first to fourth source drivers by a clock signal, a display voltage corresponding to luminance of each of the pixel sections is outputted from each of the source voltage lines. At this moment, a vertical shift clock signal and a gate start pulse signal are supplied as necessary to a gate driver corresponding to a gate voltage line on which an image is to be displayed with electric charges (display voltage) supplied to the source voltage line, and a scanning signal of the gate voltage line concerned becomes in on-state. On the other hand, a gate driver which is not operated for image display receives an enable signal at low level, and the scanning signal of the corresponding gate voltage line becomes in off-state.

In an example of FIG. 5, as indicated by an arrow D4, after the image signals of one horizontal line on an Mth line of an N-1th frame are transmitted to a source driver, an enable signal at high level is supplied from the control LSI 30 to the third gate driver 14c, as indicated by an arrow D5, and a start pulse signal and a vertical shift clock signal are supplied to the third gate driver 14c, as indicated by arrows D6 and D7. This turns on a TFT 12b connected to the first gate voltage line of the third gate driver 14c corresponding to the Mth line on which an image is to be displayed on the screen, as indicated by an arrow D8. As a result of this, the image is displayed. At this moment, an enable signal at low level is supplied to the first gate driver 14a, the second gate driver 14b, and the fourth gate driver 14c, and TFTs 12b connected to respective gate voltage lines of the first gate driver 14a, the second gate driver 14b, and the fourth gate driver 14c are turned off.

Next, as indicated by an arrow D9, after an image signal of one horizontal line on the first line of the Nth frame is transmitted to a source driver, an enable signal at high level is supplied from the control LSI 30 to the first gate driver 14a, as indicated by an arrow D10, and a start pulse signal and a vertical shift clock signal are supplied to the first gate driver 14a, as indicated by arrows D11 and D12. This turns on a TFT 12b connected to a first gate voltage line of the first gate driver 14a corresponding to the first line on which an image is to be displayed on the screen, as indicated by an arrow D13. As a result of this, the image is displayed. At this moment, an enable signal at low level is supplied to the second to fourth gate drivers 14b through 14c, and TFTs 12b connected to respective gate voltage lines of the second to fourth gate drivers 14b through 14c are turned off.

The operations described above with reference to FIG. 5, are merely exemplary operations for time-division driving of the image display apparatus 1, and the present invention is not limited to this.

For example, the above description assumes that a frame is divided into two sub-frames. However, the number of frame subdivisions is not limited to this. Alternatively, a frame may be divided into three or more sub-frames. Further, a division proportion between the sub-frames is not limited to 1:1, and a frame is not necessarily divided into sub-frames of equal parts. Alternatively, a frame can be divided into sub-frames at a given division proportion (e.g. 2:1 or 3:2). These are also applied to Second through Sixth Embodiments, which will be described later.

Next, the following will describe operations of the image display apparatus 1 in the second display mode with reference to FIG. 6. FIG. 6 shows a period during which image input signals of first to sixth lines of an Nth frame is supplied.

As indicated by an arrow D21 of FIG. 6, at the operations in the second display mode, an input image signal supplied to the control LSI 30 is directly outputted, as a panel image signal, from the control LSI 30 via only the output data selector 37.

When a latch pulse signal is supplied after the panel image signal of one horizontal line, which signal is outputted from the control LSI 30, is transmitted to the first to fourth source drivers in sync with a clock signal, a display voltage corresponding to luminance of each of the pixel sections is outputted from each of the source voltage lines.

In an example of FIG. 6, as indicated by an arrow D22, after an image signal of one horizontal line on a first line of the Nth frame is transmitted to a source driver, an enable signal at high level is supplied from the control LSI 30 to the first gate driver 14a, as indicated by an arrow D23. Then, a start pulse signal and a vertical shift clock signal are supplied to the first gate driver 14a, as indicated by arrows D24 and D25. This turns on a TFT 12b connected to a first gate voltage line of the first gate driver 14a, as indicated by an arrow D26. As a result of this, the image is displayed. At this moment, an enable signal at low level is supplied to the second gate driver 14b, the third gate driver 14c, and the fourth gate driver 14d, and TFTs 12b connected to respective gate voltage lines of the second gate driver 14b, the third gate driver 14c, and the fourth gate driver 14d are turned off.

Thereafter, data transmission to each of the second and subsequent gate lines of the Nth frame is performed. As indicated by arrows D27 through D30, when a latch pulse signal is supplied after an image signal of one horizontal line is transmitted to a source driver, a display voltage corresponding to luminance of each of the pixel sections is outputted from each source voltage line.

Upon completion of writing to pixels connected to a final gate voltage line of the first gate driver 14a, an enable signal at high level is supplied to the second gate driver 14b, and a start pulse signal and a vertical shift clock signal are supplied to the second gate driver 14b. This causes an image to be displayed in an area corresponding to gate voltage lines driven by the second gate driver 14b. Similarly, an image is displayed in an area corresponding to gate voltage lines driven by the third gate driver 14c and the fourth gate driver 14d.

The image display apparatus 1 of First Embodiment assumes that switching between display modes is performed according to user's instruction entered by means of the mode selector switch 50. However, an image display apparatus according to the present invention can be arranged such that the apparatus itself determines what image is to be displayed, and automatically selects a suitable display mode according to a result of the determination. Such an image display apparatus will be described in Second through Fourth Embodiments.

### Second Embodiment

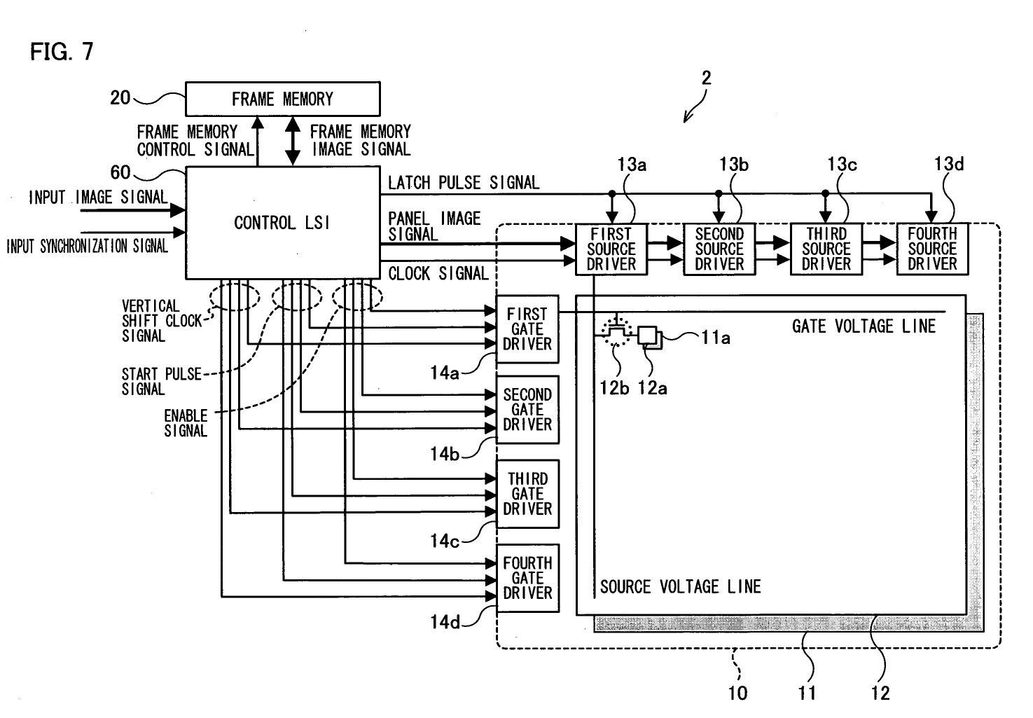

An image display apparatus of Second Embodiment is the one as illustrated in FIG. 7. An image display apparatus 2 illustrated in FIG. 7 is different from the image display apparatus 1 illustrated in FIG. 2 in that the image display apparatus 2 does not include the mode selector switch 50 and includes a control LSI 60, instead of the control LSI 30. Except for these differences, the structure of the image display apparatus 2 is identical with that of the image display apparatus 1. As such, members having the same structures and operations as those of the image display apparatus 1 are given the same reference numerals shown in FIG. 2, and detailed explanations thereof are omitted.

In the image display apparatus 2, the control LSI 60 determines whether an image to be displayed is a moving image or a still image on the basis of an input image signal, and the control LSI 60 selects a suitable display mode according to a result of the determination. More specifically, the time-division driving performed by the image display apparatus of the present invention is effective in suppressing blurring of a moving image, but is ineffective (or less effective) in displaying a still image (or a moving image that is close to a still image and has a small amount of motion). As such, it is preferable that in a case where an image to be displayed is a moving image, display is performed in the first display mode in which time-division driving is performed to give a high priority to the effect on blurring of a moving image, and in a case where an image to be displayed is a still image, display is performed in the second display mode in which hold driving is performed, in consideration of suppression of flickers.

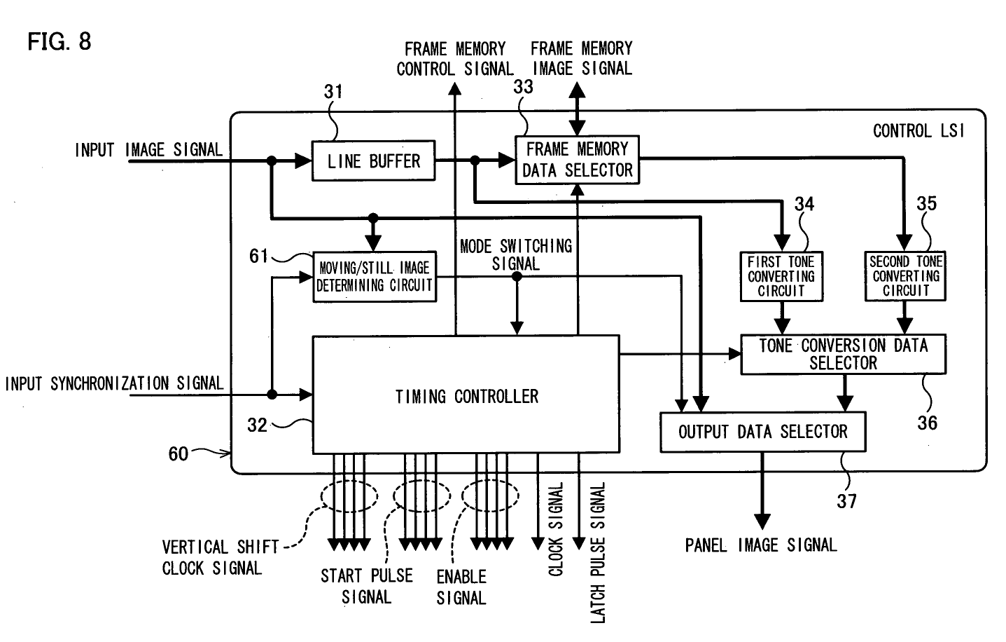

The structure of the control LSI 60 which performs such a display mode change will be described with reference to FIG. 8. As opposed to the control LSI 30 illustrated in FIG. 1, the control LSI 60 further includes a moving/still image determining circuit 61. Other members having the same structures and operations as those of the control LSI 30 are given the same reference numerals shown in FIG. 1, and detailed explanations thereof are omitted.

The moving/still image determining circuit 61 receives an input image signal and an input synchronization signal, determines whether an image to be displayed is a moving image or a still image on the basis of the input image signal and the input synchronization signal, and then outputs a mode switching signal according to a result of the determination. The mode switching signal outputted from the moving/still image determining circuit 61 is supplied to the timing controller 32 and the output data selector 37. In other words, in the image display apparatus 2 illustrated in FIG. 7, the mode switching signal is not the one generated by user's entry, but generated by the moving/still image determining circuit 61 on the basis of what image is to be displayed.

Here, as a moving image/still image determination method performed by the moving/still image determining circuit 61, the following methods are considered available. For example, there are a method in which data corresponding to a pixel at the same location is compared between successive frames in order to determine whether there is difference between the frames, and a method in which a motion vector of an image to be displayed is extracted from successive frames in order to determine whether the image to be displayed is a moving image or a still image on the basis of a size of the motion vector. Note that a moving/still image determining method is the technique that has been already applied to operations including image compression, and any known method can be used as a moving/still image determining method. Therefore, in the present invention, a specific method for moving image/still image determination is not particularly limited.

Further, the moving/still image determining circuit 61 determines whether an image to be displayed is a moving image or a still image. The still image herein includes not only a completely still image without any motions, but also an image with a relatively small amount of motion, as compared with the moving image herein.

The moving/still image determining circuit 61 can determine whether an image to be displayed is an image with a large amount of motion (determined as a moving image) or an image with a small amount of motion (determined as a still image) by comparing data corresponding to a pixel at the same location between successive frames, counting pixels which have difference in displaying between the frames, and comparing the number of such pixels with a predetermined threshold.

### Third Embodiment

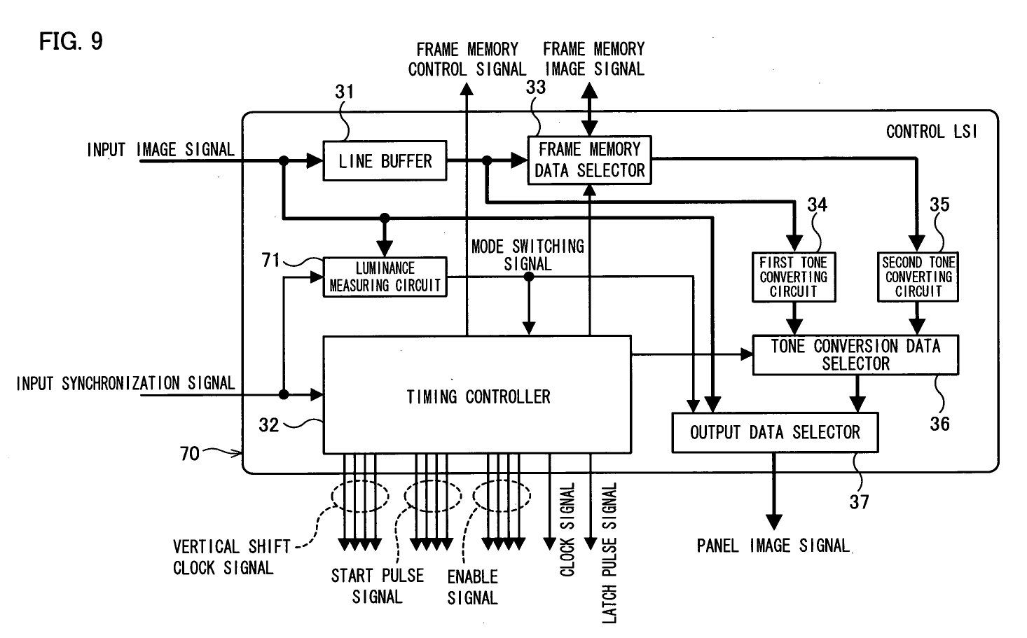

An image display apparatus of Third Embodiment is nearly identical in structure with the image display apparatus 2 illustrated in FIG. 7, but includes a control LSI 70 illustrated in FIG. 9, instead of the control LSI 60. The control LSI 70 includes a luminance measuring circuit 71, instead of the moving/still image determining circuit 61, as opposed to the control LSI 60 illustrated in FIG. 8.

In the image display apparatus of Third Embodiment, the control LSI 70 measures (calculates) average luminance of an input image signal, and then selects a suitable display mode according to a result of the measurement. More specifically, in the case of the time-division driving performed by the image display apparatus of the present invention, it is generally easy to recognize flickers when luminance of an image to be displayed is high, but it is difficult to recognize flickers when luminance of an image to be displayed is low. As such, it is preferable that in a case where luminance of an image to be displayed is low, display is performed in the first display mode in which time-division driving is performed to give a high priority to the effect on blurring of a moving image, and in a case where luminance of an image to be displayed is high, display is performed in the second display mode in which hold driving is performed, in consideration of suppression of flickers.

As illustrated in FIG. 9, the luminance measuring circuit 71 receives an input image signal and an input synchronization signal, measures (calculates) an average luminance of an image to be displayed on the basis of the input image signal and the input synchronization signal, and then outputs a mode switching signal according to a result of the measurement. The mode switching signal outputted from the luminance measuring circuit 71 is supplied to the timing controller 32 and the output data selector 37. Note that at the calculation of an average luminance, tone value data in the input image signal is used practically.

Here, as a luminance measuring method performed by the luminance measuring circuit 71, the following method is considered available. For example, there is a method in which an average value (i.e. average luminance) of luminance data of a plurality of pixels in a frame is calculated. The average luminance may be calculated for a single frame, or may be calculated for successive frames. Further, the average luminance may be calculated by using all pixels in a frame or may be calculated by using part of pixels extracted from a frame. Note that a luminance measuring method is the technique that has been already applied to, for example, operations including control of a backlight of a liquid crystal display apparatus according to luminance of an image to be displayed, and any known methods can be used as a luminance measuring method. Therefore, in the present invention, a specific method for luminance measurement is not particularly limited.

### Fourth Embodiment

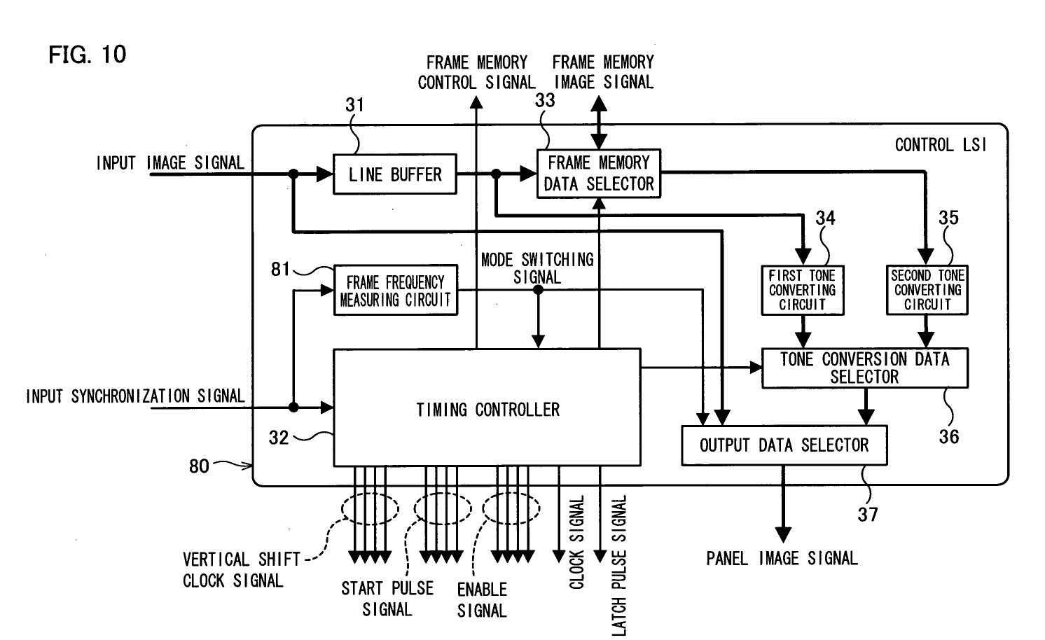

An image display apparatus of Fourth Embodiment is nearly identical in structure with the image display apparatus 2 illustrated in FIG. 7, but includes a control LSI 80 illustrated in FIG. 10, instead of the control LSI 60. The control LSI 80 includes a frame frequency measuring circuit 81, instead of the moving/still image determining circuit 61, as opposed to the control LSI 60 illustrated in FIG. 8.

In the image display apparatus of Fourth Embodiment, the control LSI 80 measures a frame frequency of an input image signal, and selects a suitable display mode according to a result of the measurement. More specifically, in the case of the time-division driving performed by the image display apparatus of the present invention, it is generally difficult to recognize flickers when a frame frequency is high, but it is easy to recognize flickers when a frame frequency is low. As such, it is preferable that in a case where a frame frequency of an image to be displayed is high, display is performed in the first display mode in which time-division driving is performed to give a high priority to the effect on blurring of a moving image, and in a case where a frame frequency of an image to be displayed is low, display is performed in the second display mode in which hold driving is performed, in consideration of suppression of flickers.

More specifically, it is preferable that in a case where a frame frequency is determined approximately 60 Hz, display is performed in the first display mode, and in a case where a frame frequency is determined approximately 50 Hz, display is performed in the second display mode. In such a case, a frame frequency threshold value, which is a criterion for changing a display mode, should be set to be in a range from 50 Hz to 60 Hz. It should be noted that the frame frequency threshold value is preferably set to be in a range from 50 Hz to 60 Hz because television image signals are generally a 50 Hz signal (PAL) and a 60 Hz signal (NTSC).

As illustrated in FIG. 10, the frame frequency measuring circuit 81 receives an input synchronization signal, measures a frame frequency of an image to be displayed on the basis of the input synchronization signal, and then outputs a mode switching signal according to a result of the measurement. The mode switching signal outputted from the frame frequency measuring circuit 81 is supplied to the timing controller 32 and the output data selector 37.

Here, as a frame frequency method performed by the frame frequency measuring circuit 81, the following method is considered available. For example, there is a method in which a synchronous counter, which is provided in the frame frequency measuring circuit 81 and operated by a clock with a fixed frequency (e.g. output of crystal oscillator), counts a vertical period of the input synchronization signal to extract a frame frequency from the input synchronization signal. However, in the present invention, a specific method for frame frequency measurement is not particularly limited.

It should be noted that the three arrangements described in Second through Fourth Embodiments can be used in combination as follows. That is, in an image display apparatus of the present invention, two of the three arrangements or all the three arrangements can be combined for use. Further, with the above arrangements, the structure of the mode selector switch 50, which has been described in First Embodiment, can be combined for use.

Still further, the moving image/still image determination process in Second Embodiment, the luminance measurement process in Third Embodiment, or the frame frequency measurement process in Fourth Embodiment can be performed without interruption during the input of image signals. However, in order to lighten load on the moving/still image determining circuit 61, the luminance measuring circuit 71, or the frame frequency measuring circuit 81, the determination or the measurement may be performed intermittently, for example, at a regular intervals.

### Fifth Embodiment

An image display apparatus of Fifth Embodiment has the feature of selecting a suitable display mode according to a supply source (image source) of an image to be displayed on the display panel 10. More specifically, in many cases, recent image display apparatuses can receive image signals from various kinds of image sources, such as a personal computer, a television tuner, a video, and a game machine. The image sources determine characteristics of a supplied image signal (especially moving image characteristics) to some extent. For example, an image of an image signal supplied from a personal computer is normally an image with low moving image characteristics (image close to a still image with a small amount of motion), as compared with an image signal supplied from other image source.

In light of this, an image display apparatus of Fifth Embodiment determines as to which image source is used. With this arrangement, for example, in a case where an image source is not a personal computer, display is performed in the first display mode in which time-division driving is performed to give a high priority to the effect on blurring of a moving image, and in a case where an image source is a personal computer, display is performed in the second display mode in which hold driving is performed, in consideration of suppression of flickers.

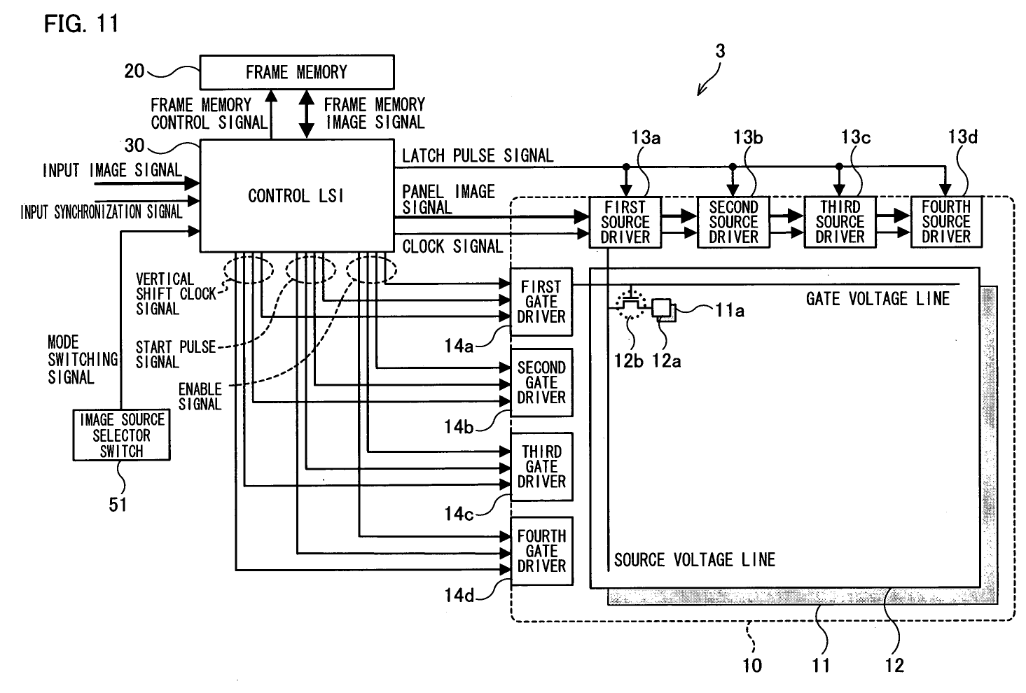

An image display apparatus that performs such a control is, for example, the one as illustrated in FIG. 11. An image display apparatus 3 illustrated in FIG. 11 is different from the image display apparatus 1 illustrated in FIG. 1 in that the image display apparatus 3 includes an image source selector switch 51, instead of the mode selector switch 50. Except for the difference, the structure of the image display apparatus 3 is identical with that of the image display apparatus 1. As such, members having the same structures and operations as those of the image display apparatus 1 are given the same reference numerals shown in FIG. 1, and detailed explanations thereof are omitted.

The image display apparatus 3 changes an image source according to user's instruction entered by means of the image source selector switch 51, and then outputs a mode switching signal according to a selected image source. The mode switching signal is supplied to the control LSI 30, and the following operations are the same as those in the image display apparatus 1 described in First Embodiment. Note that control for change of an image source is commonly performed by an image display apparatus capable of displaying image signals from a plurality of image sources, and detailed explanation thereof is therefore omitted.

Further, the arrangement described in Fifth Embodiment can be used in combination with any of the arrangements described in First through Fourth Embodiments.

### Sixth Embodiment

An image display apparatus of Sixth Embodiment, as with the image display apparatuses of Second and Third Embodiments, is arranged such that the apparatus itself determines what image is to be displayed, and automatically selects a suitable display mode according to a result of the determination. Although the image display apparatuses of Second and Third Embodiments change a display mode for each entire frame image, the image display apparatus of Sixth Embodiment performs the determination for each pixel of a frame image, and changes a display mode for each pixel subjected to the determination.

For example, the image display apparatus of Sixth Embodiment determines a pixel on which a moving image is to be displayed and a pixel on which a still image is to be displayed in an input image. As such, it is possible that for a pixel on which a moving image is to be displayed, display is performed in the first display mode in which time-division driving is performed to give a high priority to the effect on blurring of a moving image, and for a pixel on which a still image is to be displayed, display is performed in the second display mode in which hold driving is performed, in consideration of suppression of flickers.

The image display apparatus that performs such display control can be basically realized by an apparatus with an arrangement similar to the image display apparatus of Second Embodiment. More specifically, although in Second Embodiment the moving/still image determining circuit 61 in the control LSI 60 determines whether an image of an entire frame is a moving image or a still image, in Sixth Embodiment the moving/still image determining circuit 61 performs moving image/still image determination pixel by pixel, changes a mode switching signal for each pixel subjected to moving image/still image determination, and output the mode switching signal.

Further, in an image display apparatus with an arrangement similar to the image display apparatus of Third Embodiment, the luminance measuring circuit 71 may measure luminance pixel by pixel, change a mode switching signal for each pixel subjected to luminance measurement, and output the mode switching signal. In this case, whether a pixel on which an image with low luminance is to be displayed or a pixel on which an image with high luminance is to be displayed is determined on the basis of an input image. As such, it is possible to perform display control such that for a pixel on which an image with low luminance is to be displayed, display is performed in the first display mode to give a high priority to the effect on blurring of a moving image, and for a pixel on which an image with high luminance is to be displayed, display is performed in the second display mode in consideration of suppression of flickers.

### Seventh Embodiment

An image display apparatus of Seventh Embodiment, as with the image display apparatuses of Second and Third Embodiments, is arranged such that the apparatus itself determines what image is to be displayed, and automatically selects a suitable display mode according to a result of the determination. Although the image display apparatuses of Second and Third Embodiments change a display mode for each entire frame image, the image display apparatus of Seventh Embodiment performs the determination on each area of a frame image, and changes a display mode for each area subjected to the determination.

For example, the image display apparatus of Seventh Embodiment determines an area where a moving image is to be displayed (moving image area) and an area where a still image is to be displayed (still image area) in an input image. As such, it is possible to perform display control such that in the moving image area display is performed in the first display mode in which time-division driving is performed to give a high priority to the effect on blurring of a moving image, and in the still image area display is performed in the second display mode in which hold driving is performed, in consideration of suppression of flickers.

Alternatively, the image display apparatus of Seventh Embodiment determines an area where an image to be displayed has a low luminance (low luminance area) and an area where an image to be displayed has a high luminance (high luminance area) in an input image. As such, it is possible to perform display control such that in the low luminance area display is performed in the first display mode to give a high priority to the effect on blurring of a moving image, and in the high luminance area display is performed in the second display mode in consideration of suppression of flickers.

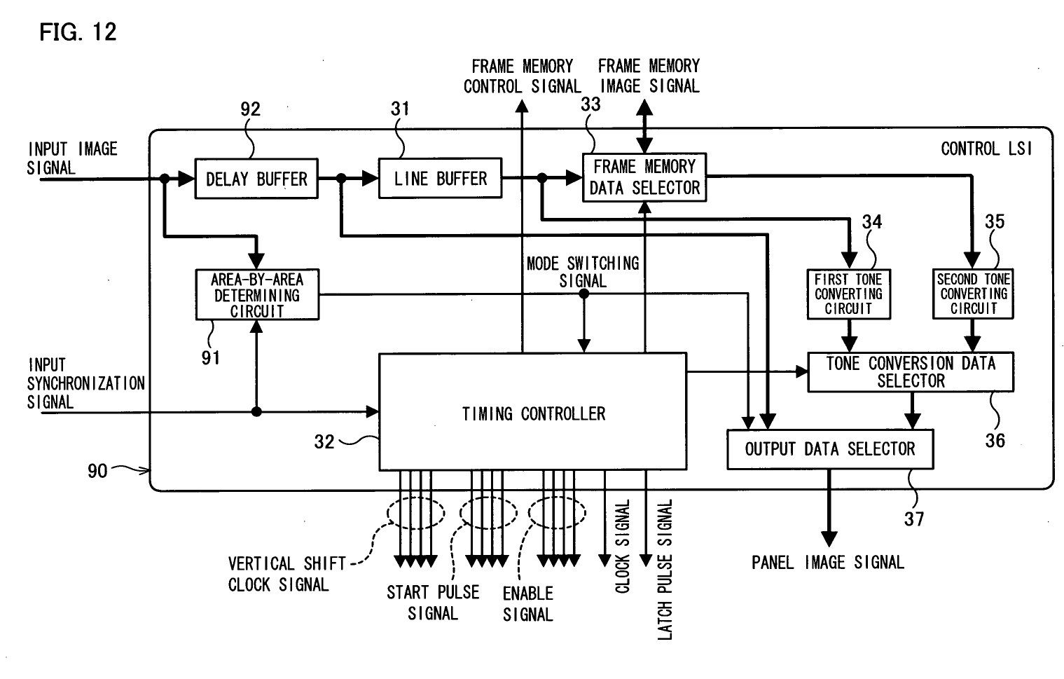

An image display apparatus of Seventh Embodiment is nearly identical in structure with the image display apparatus 2 illustrated in FIG. 7, but includes a control LSI 90 illustrated in FIG. 12, instead of the control LSI 60. The control LSI 90 further includes an area-by-area determining circuit 91 and a delay buffer 92, as opposed to the control LSI 30 illustrated in FIG. 1.

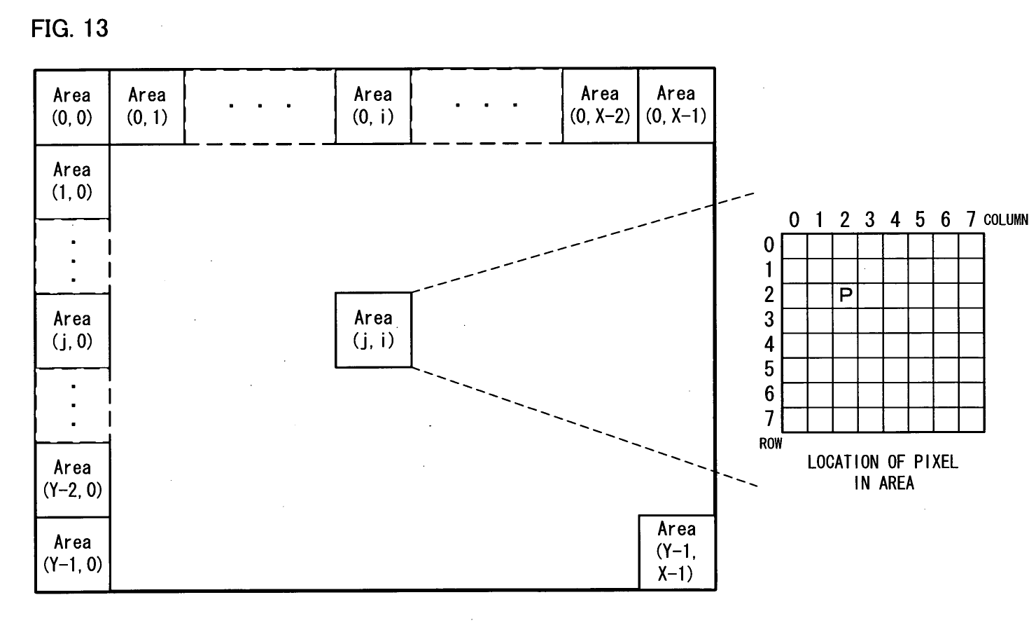

The area-by-area determining circuit 91 receives an input image signal and an input synchronization signal. On the basis of these input signals, the area-by-area determining circuit 91 determines the nature of an input image signal for each predetermined block area, and outputs a mode switching signal according to a result of the determination. For example, as illustrated in FIG. 13, the area-by-area determining circuit 91 divides a display screen into a plurality of block areas, and performs determination of the nature of an input image and switching of a mode switching signal, for each of the block areas. In FIG. 13, the display screen is divided into block areas in Y rows and in X columns. Each of the block areas has 8-by-8 pixels.

The area-by-area determining circuit 91 collects all information items of all pixels in a block area and then obtains a result of the determination of the nature of the block area. Accordingly, there occurs a delay time before a mode switching signal is outputted. The delay buffer 92 is provided at the preceding stage of the line buffer 31. This is because the delay buffer 92 synchronizes a timing of a mode switching signal outputted from the area-by-area determining circuit 91 and a timing of an image signal outputted as a panel image signal, in view of the delay time.

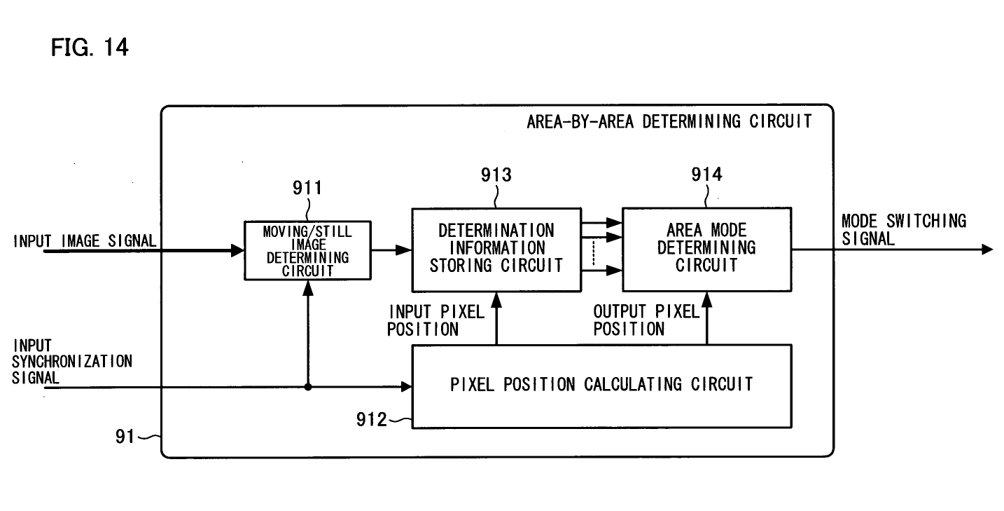

Here, the following will describe an exemplary structure of the area-by-area determining circuit 91 with reference to FIG. 14. An arrangement of the area-by-area determining circuit 91 illustrated in FIG. 14 exemplifies an arrangement in a case where an area where a moving image is to be displayed (moving image area) and an area where a still image is to be displayed (still image area) are determined on the basis of input image.

The area-by-area determining circuit 91 includes a moving/still image determining circuit 911, a pixel position calculating circuit 912, a determination information storing circuit 913, and an area mode determining circuit 914.

The moving/still image determining circuit 911, which essentially has the same function as that of the moving/still image determining circuit 61 of Second Embodiment, can perform moving image/still image determination pixel by pixel on the basis of an input image signal. For example, when determining as a moving image, the moving/still image determining circuit 911 outputs 1 to the determination information storing circuit 913. Meanwhile, when determining as a still image, the moving/still image determining circuit 911 outputs 0 to the determination information storing circuit 913.

The pixel position calculating circuit 912 calculates a position of an input pixel on the screen and a position of an output pixel on the screen on the basis of an input synchronization signal.

The determination information storing circuit 913 stores a result of the determination made by the moving/still image determining circuit 911, according to the position of the input pixel on the screen, which position is received from the pixel position calculating circuit 912. More specifically, the determination information storing circuit 913 sequentially stores a result of the determination (1 or 0) made by the moving/still image determining circuit 911, at an address corresponding to the input pixel position (position of a current input pixel on the screen), which is received from the pixel position calculating circuit 912. For example, assume that in case of display in 480-by-640 pixel resolution, a current input pixel is located at 50 in column and 100 in row. In this case, one bit (1 or 0) information of a result of the moving image/still image determination is stored at an address (50, 100).

On the basis of an output pixel position on the screen, which is received from the pixel position calculating circuit 912, the area mode determining circuit 914 reads out a result of the determination for a block area to which an output pixel belongs from the determination information storing circuit 913, performs operation on the output pixel position and the result of the determination, determines a mode of the block area, and outputs a mode switching signal.

Upon receipt of an output pixel position (position of a pixel to which a mode switching signal is about to be outputted on the screen) from the pixel position calculating circuit 913, the area mode determining circuit 914 calculates which of the block areas this pixel is included in. Take a pixel P in FIG. 13 as an example. The calculation finds out that the pixel P is included in a block area, Area (j, i). Equations for the calculation depend on a size of a block area. More specifically, when a display screen is divided into block areas each of which has M-by-N pixels (M and N are integers), the block area Area (j, i) including the pixel P therein is derived from the following equations:

j=int(Py÷M)

i=int(Px÷N),

where Y coordinate (ordinate) and X coordinate (abscissa) of the pixel P on the screen are respectively Py and Px, and int ( ) is a function that converts a value with parentheses into an integer by dropping the fractional portion of the value.

For example, assume that when each block area has 8-by-8 pixels and the output pixel position is at column 50 (Py) and row 100 (Px). The block area of the pixel P is found as follows:

i=int(50÷8)=int(6.25)=6

j=int(100÷8)=int(12.5)=12.

Thus, the calculation finds out that the pixel P is included in a block area, Area (6, 12) in FIG. 13.

Next, the area mode determining circuit 914 reads out, at a time, determination results on all the pixels in a block that has been found from the output pixel position, from determination information storing circuit 913. Then, the area mode determining circuit 914 determines which of moving image pixel and still image pixel is more in all the pixels (i.e. determines which of count of “0”s and count of “1”s is more).

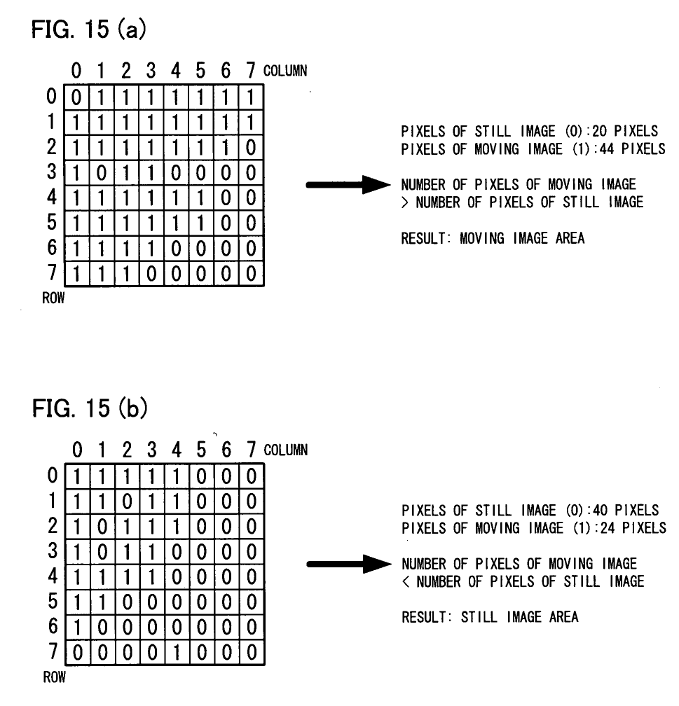

For example, FIG. 15(a) illustrates a result that count of still image pixels (0) is 20 and count of moving image pixels (1) is 44 in a block area with 8-by-8 pixels. In this case, since count of moving image pixels (1) is more in this block area, the area mode determining circuit 914 determines that this block area is a moving image area. Then, the area mode determining circuit 914 outputs a mode switching signal such that display will be performed in the first display mode for better moving image display performance.

In an example of FIG. 15(b), since the number of still image pixels is more, the area mode determining circuit 914 determines that this block area is a still image area. Then, the area mode determining circuit 914 outputs a mode switching signal such that display will be performed in the second display mode for suppression of flickers.

Further, a method for determining the nature of a block area is not limited to the above-mentioned method, i.e. the method in which the nature of a block area is determined from which is more, moving image pixels or still image pixels. Alternatively, other method can be adopted to realize more simple circuit configuration and a smaller capacity for storage of the determination results.

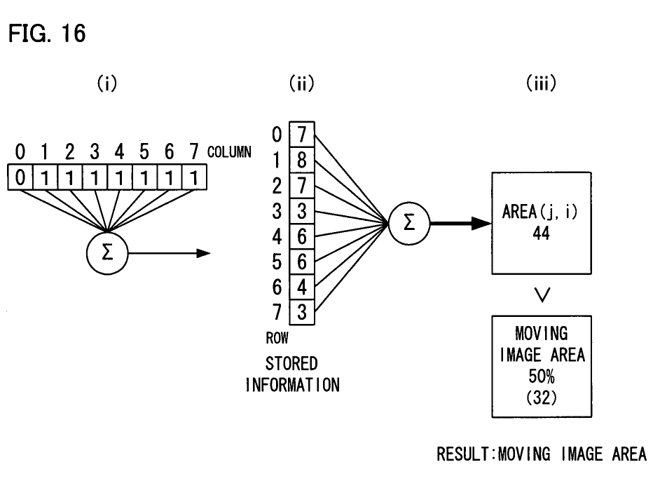

Other method for determining the nature of a block area will be described below with reference to FIG. 16.

In step (i) in FIG. 16, the determination information storing circuit 913 performs in advance additions of determination results (1 or 0) regarding pixels of a moving image or pixels of a still image, for each row of the block area, and then stores respective values obtained by the row-by-row additions as shown in step (ii). In FIG. 16, the determination information storing circuit 913 stores the values obtained by additions of the numbers of moving image pixels shown in FIG. 15(a). The foregoing method (method of determining from which is more, pixels of moving image or pixels of still image) needs 64 bits (8-bit by 8-bit) to store information regarding one block area in the determination information storing circuit 913. On the contrary, the method shown in FIG. 16 only needs 32 bits, which is half of 64 bits, to store information regarding one block area in the determination information storing circuit 913. This is because the row-by-row addition of determination results in a block realizes 4 bits for each row.

Accordingly, in reading out stored information from the determination information storing circuit 913, the area mode determining circuit 914 does not need to count “1”s and “0”s in the block. Instead, as shown in the steps (ii) and (iii), the area mode determining circuit 914 can obtain the number of moving image pixels in the block area by reading out 4-bit data each for 8 columns and adding the read data. Then, by comparing the obtained number of pixels of moving image in the block area with 32, which is 50% of the number of all pixels in the block area, the area mode determining circuit 914 can determine whether the block area is a moving image area or a still image area.

A method of switching between signal generating means that generates the panel image signals according to a mode switching signal, is the same as those of the foregoing embodiments, and detailed explanation thereof is therefore omitted.

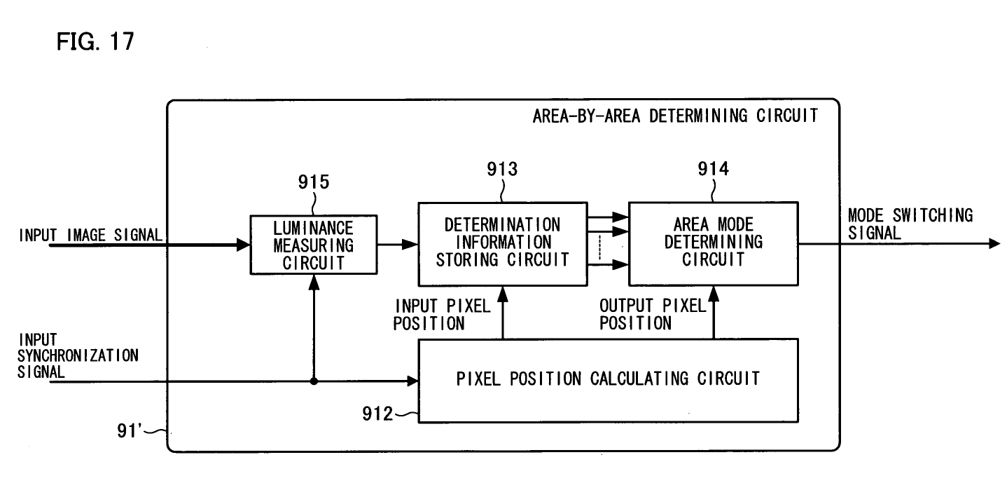

Further, when the control LSI 90 arranged as illustrated in FIG. 12 uses an area-by-area determining circuit 91′ illustrated in FIG. 17, instead of the area-by-area determining circuit 91, it is possible to determine an area where an image to be displayed has a low luminance (low luminance area) and an area where an image to be displayed has a high luminance (high luminance area) in an input image, and perform display control according to a result of the determination.

The area-by-area determining circuit 91′ has a luminance measuring circuit 915, instead of the moving/still image determining circuit 911, and the other members can be the same as those of the area-by-area determining circuit 91 illustrated in FIG. 14. The luminance measuring circuit 915, which is basically of the same function as the luminance measuring circuit 71 discussed in Third Embodiment, can perform high luminance/low luminance determination pixel by pixel on the basis of an input image signal. For example, when determining as high luminance, the moving/still image determining circuit 911 outputs 1 to the determination information storing circuit 913. Meanwhile, when determining as low luminance, the moving/still image determining circuit 911 outputs 0 to the determination information storing circuit 913. The subsequent operations can be the same as the operations of the area-by-area determining circuit 91, and detailed explanation thereof is therefore omitted.

In the above descriptions, an image to be displayed is divided into block areas each of which has 8-by-8 pixels. However, the block area is not limited to 8-by-8 pixel size block area. The block area can be made up of N-by-M pixels (N and M are positive integers).

Further, sub-areas of an image to be displayed are not limited to square blocks. The sub-areas can be of any shape. Still further, a size of sub-areas of an image to be displayed is limited to equal size. A size of the sub-areas may be changed according to an input image signal. For example, when an area with fine patterns in an input image is divided into small sub-areas, and an area with large patterns is divided into large sub-areas, it is possible to perform processing that more appropriately matches the image.

Further, in the above example, a mode of a sub-area is determined based on majority rule, i.e. using a criterion of 50% of the number of pixels in the sub-area. However, the criterion, which is not limited to 50%, may be a low criterion of 30%, or may be a high criterion of 70%. By making the criterion varied by an external operation, it is possible to adjust a quality of a moving image to meet user preferences.

The image display apparatuses of First through Seventh Embodiments can serve as an image display monitor including a liquid crystal monitor, and can also serve as a television receiver.

The image display apparatus serving as an image display monitor is realized by being provided with a signal input section (e.g. port for input) which feeds an image signal supplied from outside to the control LSI. Meanwhile, the image display apparatus serving as a television receiver is realized by being provided with a tuner section. The tuner section selects a channel of a television broadcasting signal, and supplies a television image signal of the selected channel, as an input image signal, to the control LSI.

In order to solve the above problem, an image display apparatus of the present invention has a first display mode and a second display mode, the first display mode being a mode in which one frame period is divided into a plurality of sub-frame periods, and luminance of the one frame period based on an input image signal is distributed to the sub-frames so that the luminance of the one frame period is reproduced by the sub-frames for image display, the second display mode being a mode in which image display during one frame period is performed at a single luminance level so that luminance of the one frame period based on an input image signal is reproduced, wherein said image display apparatus switches between the first display mode and the second display mode to perform image display.

According to the above arrangement, the image display apparatus has the first display mode and the second display mode. In the first display mode, one frame period is divided into a plurality of sub-frame periods, and luminance of the one frame period based on an input image signal is distributed to the sub-frames so that the luminance of the one frame period is reproduced by the sub-frames for image display (so-called time-division driving display). In the second display mode, image display during one frame period is performed at a single luminance level so that luminance of the one frame period based on an input image signal is reproduced (so-called hold driving display). In the image display apparatus, it is possible to switch between the first display mode and the second display mode.

With this arrangement, in order to suppress blurring of a moving image, a display image signal can be generated by time-division driving, which is highly effective in suppressing blurring of a moving image (display in the first display mode). In order to suppress flickers, a display image signal can be generated by hold driving, in which flickers are less likely to occur (display in the second display mode). This makes it possible to effectively obtain the effect of suppressing blurring of a moving image by pseudo-impulse driving and to alleviate the problem of flickers caused by pseudo-impulse driving.

Further, the image display apparatus may be arranged such that in the second display mode the one frame period is regarded as a single frame period so that a predetermined luminance is reproduced during the one frame period.

Still further, the image display apparatus may be arranged such that in the second display mode the one frame period is divided into a plurality of sub-frame periods, and luminance levels inputted into the respective sub-frames are equal to each other.

Yet further, the image display apparatus may be arranged such that the image display apparatus has switching means that switches between the first display mode and the second display mode.

Further, the image display apparatus may be arranged such that switching between the first display mode and the second display mode is performed by an external input operation.

Still further, the image display apparatus may be arranged such that switching between the first display mode and the second display mode is performed according to nature of an input image.

Yet further, the image display apparatus may be arranged such that the image display apparatus determines whether the input image is a moving image or a still image to switch between the first display mode and the second display mode.

Further, the image display apparatus may be arranged such that when the input image is determined as a moving image, the first display mode is selected, and when the input image is determined as a still image, the second display mode is selected.

Still further, the image display apparatus may be arranged such that switching between the first display mode and the second display mode is performed according to average luminance of the input image.

Yet further, the image display apparatus may be arranged such that when the average luminance of the input image is determined as being low, the first display mode is selected, and when the average luminance of the input image is determined as being high, the second display mode is selected.

Further, the image display apparatus may be arranged such that switching between the first display mode and the second display mode is performed according to frame frequency of the input image.

Still further, the image display apparatus may be arranged such that when the frame frequency of the input image is determined as being high, the first display mode is selected, and when the frame frequency of the input image is determined as being low, the second display mode is selected.

Yet further, the image display apparatus may be arranged such that a frame frequency threshold value, which is a criterion for switching between the first display mode and the second display mode, is set to be in a range from 50 Hz to 60 Hz.

Further, the image display apparatus may be arranged such that switching between the first display mode and the second display mode is performed according to a result of image source determination in which a supply source of the input image is determined.

Still further, the image display apparatus may be arranged such that the nature of the input image is determined for each of pixels on the basis of the input image signal, and switching between the first display mode and the second display mode is performed according to a result of the determination.

Yet further, the image display apparatus may be arranged such that the nature of the input image is determined for each of sub-areas on the basis of the input image signal, switching between the first display mode and the second display mode is performed according to a result of the determination.

In order to solve the above problem, another image display apparatus of the present invention includes: first signal generating means that divides one frame period into a plurality of sub-frame periods, and generates a display image signal such that luminance of the one frame period based on an input image signal is distributed to the sub-frames so that the luminance of the one frame period is reproduced by a sum total of time integral values of luminance of the respective sub-frames; and second signal generating means that generates a display image signal such that the one frame period is regarded as a single frame period so that a predetermined luminance is reproduced during the one frame period, wherein switching between output of the first signal generating means and output of the second signal generating means is performed so that the display image signal is outputted to a display section.

Further, the image display apparatus can be arranged so as to further include: switching means that switches between output-of the first signal generating means and output of the second signal generating means to output the display image signal to the display section.

In the image display apparatus which performs time-division driving, luminance is distributed to the sub-frames so that luminance characteristics during one frame period based on an input image signal are realized by time integral values of luminance of the respective sub-frames. Time-division driving display becomes pseudo-impulse display when a sub-frame with high luminance and a sub-frame with low luminance are caused by the luminance distribution to the sub-frames as described above, thus exerting the effect on blurring of a moving image. However, the time-division driving produces the effect of suppressing blurring of a moving image, but gives rise to the problem that flickers are likely to occur.

According to the above arrangement, the image display apparatus has the first display mode in which image display is performed by time-division driving and the second display mode in which image display is performed by hold driving. In addition, the image display apparatus includes the first signal generating means that generates a display image signal in performing image display in the first display mode and the second signal generating means that generates a display image signal in performing image display in the second display mode, and can switch between the first signal generating means and the second signal generating means for use. That is, switching between the first display mode in which image display is performed by time-division driving and the second display mode in which image display is performed by hold driving is performed.

With this arrangement, in order to suppress blurring of a moving image, a display image signal can be generated by time-division driving, which is highly effective in suppressing blurring of a moving image (display in the first display mode). In order to suppress flickers, a display image signal can be generated by hold driving, in which flickers are less likely to occur (display in the second display mode). This makes it possible to effectively obtain the effect of suppressing blurring of a moving image by pseudo-impulse driving and to alleviate the problem of flickers caused by pseudo-impulse driving.

Further, the image display apparatus can be arranged such that switching between output of the first signal generating means and output of the second signal generating means is able to be performed by an external input operation.

According to the above arrangement, it is possible for a user to perform an operation of switching between display modes, and it is possible to obtain a displayed image such that blurring of a moving image and flickers are adjusted to meet user preferences.

Further, the image display apparatus, further includes: determining means that determines nature of an input image on the basis of an input image signal, wherein switching between output of the first signal generating means and output of the second signal generating means is performed according to a result of the determination performed by the determining means.

According to the above arrangement, switching between the display modes is performed according a result of the determination of the nature of an input image by the determination means. This makes it possible to appropriately perform switching between the display modes while saving the user from having to do a complex procedure.

Further, the image display apparatus can be arranged such that the determining means is moving/still image determining means that determines whether the input image is a moving image or a still image. At this moment, it is preferable that when the input image is determined as a moving image, the output of the first signal generating means is supplied as the display image signal to the display section, and when the input image is determined as a still image, the output of the second signal generating means is supplied as the display image signal to the display section.

According to the above arrangement, the moving/still image determining means determines whether the input image is a moving image or a still image, and selects a suitable display mode according to a result of the determination. More specifically, the time-division driving performed by the image display apparatus is effective in suppressing blurring of a moving image, but is ineffective (or less effective) in displaying a still image (or a moving image that is close to a still image and has a small amount of motion). As such, it is possible that in a case where an image to be displayed is a moving image, display is performed in the first display mode to give a high priority to the effect on blurring of a moving image, and in a case where an image to be displayed is a still image, display is performed in the second display mode in consideration of suppression of flickers.

Further, the image display apparatus can be arranged such that the determining means is luminance measuring means that measures average luminance of the input image. At this moment, it is preferable that when the average luminance of the input image is determined as being low, the output of the first signal generating means is supplied as the display image signal to the display section, and when the average luminance of the input image is determined as being high, the output of the second signal generating means is supplied as the display image signal to the display section.

According to the above arrangement, the luminance measuring means measures average luminance of an input image, and then selects a suitable display mode according to a result of the measurement. More specifically, in the case of the time-division driving performed by the image display apparatus, it is generally easy to recognize flickers when luminance of an image to be displayed is high, but it is difficult to recognize flickers when luminance of an image to be displayed is low. As such, it is possible that in a case where luminance of an image to be displayed is low, display is performed in the first display mode to give a high priority to the effect on blurring of a moving image, and in a case where luminance of an image to be displayed is high, display is performed in the second display mode in consideration of suppression of flickers.

Further, the image display apparatus can be arranged such that the determining means is frame frequency measuring means that measures frame frequency of the input image. At this moment, it is preferable that when the frame frequency of the input image is determined as being high, the output of the first signal generating means is supplied as the display image signal to the display section, and when the frame frequency of the input image is determined as being low, the output of the second signal generating means is supplied as the display image signal to the display section.

According to the above arrangement, the frame frequency measuring means measures a frame frequency of an input image, and selects a suitable display mode according to a result of the measurement. More specifically, in the case of the time-division driving performed by the image display apparatus, it is generally difficult to recognize flickers when a frame frequency is high, but it is easy to recognize flickers when a frame frequency is low. As such, it is preferable that in a case where a frame frequency of an image to be displayed is high, display is performed in the first display mode to give a high priority to the effect on blurring of a moving image, and in a case where a frame frequency of an image to be displayed is low, display is performed in the second display mode in consideration of suppression of flickers.

Further, it is preferable that the image display apparatus has a threshold value set to be in a range from 50 Hz to 60 Hz, as a frame frequency threshold value that is a criterion for switching between the display modes.

According to the above arrangement, it is possible to switch between the display modes in a range from frame frequency of 50 Hz (PAL) to frame frequency of 60 Hz (NTSC) which are generally used as television image signals.

Further, the image display apparatus further includes: image source determining means that determines a supply source of the input image, wherein the switching means switches between the output of the first signal generating means and the output of the second signal generating means according to a result of the determination performed by the image source determining means.

According to the above arrangement, the image source determining means determines a supply source of an input image, and selects a suitable display mode according to a result of the determination. More specifically, in many cases, recent image display apparatuses can receive image signals from various kinds of image sources, such as a personal computer, a television tuner, a video, and a game machine. The image sources determine characteristics of a supplied image signal (especially moving image characteristics) to some extent.

Thus, the image display apparatus can determine an image source, and in a case where the image source is, for example, a source which supplies an image with low moving image characteristics (e.g. personal computer), display is performed in the second display mode in consideration of suppression of flickers. In a case where the image source is, for example, a source which supplies an image with high moving image characteristics, display is performed in the first display mode to give a high priority to the effect on blurring of a moving image.

Further, the image display apparatus can be arranged such that the determining means determines the nature of the input image for each of pixels on the basis of the input image signal, and switching between the output of the first signal generating means and the output of the second signal generating means is performed for each of the pixels according to a result of the determination performed by the determining means.

Still further, the image display apparatus can be arranged such that the determining means is moving/still image determining means that determines for each of pixels whether the pixel corresponds to a moving image or a still image on the basis of the input image, wherein for a pixel which is determined as corresponding to a moving image on the basis of the input image, the output of the first signal generating means is outputted as the display image signal to the display section, and for a pixel which is determined as corresponding to a still image on the basis of the input image, the output of the second signal generating means is outputted as the display image signal to the display section.

Alternatively, the image display apparatus can be arranged such that the determining means is luminance measuring means that measures luminance of each of pixels in the input image, wherein for a pixel of which luminance is determined as being low in the input image, the output of the first signal generating means is supplied as the display image signal to the display section, and for a pixel of which luminance is determined as being high in the input image, the output of the second signal generating means is supplied as the display image signal to the display section.

According to the above arrangement, for example, the image display apparatus determines an area where a moving image is to be displayed (moving image area) and an area where a still image is to be displayed (still image area) in an input image. As such, it is possible to perform display control such that in the moving image area display is performed in the first display mode to give a high priority to the effect on blurring of a moving image, and in the still image area display is performed in the second display mode in consideration of suppression of flickers.

Alternatively, the image display apparatus determines an area where an image to be displayed has a low luminance (low luminance area) and an area where an image to be displayed has a high luminance (high luminance area) in an input image. As such, it is possible to perform display control such that in the low luminance area display is performed in the first display mode to give a high priority to the effect on blurring of a moving image, and in the high luminance area display is performed in the second display mode in consideration of suppression of flickers.

Further, the image display apparatus can be arranged such that the determining means determines the nature of the input image for each of sub-areas on the basis of the input image signal, and switching between the output of the first signal generating means and the output of the second signal generating means is performed for each of the sub-areas according to a result of the determination performed by the determining means.

Further, the image display apparatus can be arranged such that the determining means is moving/still image determining means that determines for each of sub-areas whether a sub-area corresponds to a moving image or a still image on the basis of the input image, and for a sub-area which is determined as corresponding to a moving image on the basis of the input image, the output of the first signal generating means is supplied as the display image signal to the display section, and for a sub-area which is determined as corresponding to a still image on the basis of the input image, the output of the second signal generating means is supplied as the display image signal to the display section.

Further, the image display apparatus can be arranged such that the determining means is luminance measuring means that measures luminance of each of sub-areas in the input image, and for a sub-area of which average luminance is determined as being low in the input image, the output of the first signal generating means is supplied as the display image signal to the display section, and for a sub-area of which average luminance is determined as being high in the input image, the output of the second signal generating means is supplied as the display image signal to the display section.

Further, it is possible to realize a liquid crystal monitor used for a personal computer by combining the image display apparatus with a signal input section for transmitting an external input image signal to the image display apparatus.

Still further, it is possible to realize a liquid crystal television receiver by combining the image display apparatus with a tuner section.

### INDUSTRIAL APPLICABILITY

An image display apparatus which performs time-division driving for suppression of blurring of a moving image is applicable to an image display apparatus which reduces flickers and uses hold-type display elements such as liquid crystal display elements or electroluminescent display elements.

1. An image display apparatus having a first display mode and a second display mode,
the first display mode being a mode in which one frame period is divided into a plurality of sub-frame periods, and luminance of the one frame period based on an input image signal is distributed to the sub-frames so that the luminance of the one frame period is reproduced by the sub-frames for image display,
the second display mode being a mode in which image display during one frame period is performed at a single luminance level so that luminance of the one frame period based on an input image signal is reproduced,
wherein said image display apparatus switches between the first display mode and the second display mode to perform image display.

2. The image display apparatus according to claim 1, wherein
in the second display mode the one frame period is regarded as a single frame period so that a predetermined luminance is reproduced during the one frame period.

3. The image display apparatus according to claim 1, wherein
in the second display mode the one frame period is divided into a plurality of sub-frame periods, and luminance levels inputted into the respective sub-frames are equal to each other.

4. The image display apparatus according to claim 1, wherein
said image display apparatus has switching means that switches between the first display mode and the second display mode.

5. The image display apparatus according to claim 1, wherein
switching between the first display mode and the second display mode is performed by an external input operation.

6. The image display apparatus according to claim 1, wherein
switching between the first display mode and the second display mode is performed according to nature of an input image.

7. The image display apparatus according to claim 6, wherein
said image display apparatus determines whether the input image is a moving image or a still image to switch between the first display mode and the second display mode.

8. The image display apparatus according to claim 7, wherein
when the input image is determined as a moving image, the first display mode is selected, and
when the input image is determined as a still image, the second display mode is selected.

9. The image display apparatus according to claim 6, wherein
switching between the first display mode and the second display mode is performed according to average luminance of the input image.

10. The image display apparatus according to claim 9, wherein
when the average luminance of the input image is determined as being low, the first display mode is selected, and
when the average luminance of the input image is determined as being high, the second display mode is selected.

11. The image display apparatus according to claim 6, wherein
said image display apparatus switches between the first display mode and the second display mode according to frame frequency of the input image.

12. The image display apparatus according to claim 11, wherein
when the frame frequency of the input image is determined as being high, the first display mode is selected, and
when the frame frequency of the input image is determined as being low, the second display mode is selected.

13. The image display apparatus according to claim 12, wherein
a frame frequency threshold value, which is a criterion for switching between the first display mode and the second display mode, is set to be in a range from 50 Hz to 60 Hz.

14. The image display apparatus according to claim 1, wherein
switching between the first display mode and the second display mode is performed according to a result of image source determination in which a supply source of the input image is determined.

15. The image display apparatus according to claim 1, wherein
the nature of the input image is determined for each of pixels on the basis of the input image signal, and switching between the first display mode and the second display mode is performed according to a result of the determination.

16. The image display apparatus according to claim 1, wherein
the nature of the input image is determined for each of sub-areas on the basis of the input image signal, switching between the first display mode and the second display mode is performed according to a result of the determination.

17. An image display apparatus comprising:
first signal generating means that divides one frame period into a plurality of sub-frame periods, and generates a display image signal such that luminance of the one frame period based on an input image signal is distributed to the sub-frames so that the luminance of the one frame period is reproduced by a sum total of time integral values of luminance of the respective sub-frames; and
second signal generating means that generates a display image signal such that the one frame period is regarded as a single frame period so that a predetermined luminance is reproduced during the one frame period,
wherein
switching between output of the first signal generating means and output of the second signal generating means is performed so that the display image signal is outputted to a display section.

18. The image display apparatus according to claim 17, further comprising:
switching means that switches between output of the first signal generating means and output of the second signal generating means to output the display image signal to the display section.

19. The image display apparatus according to claim 17, wherein
switching between output of the first signal generating means and output of the second signal generating means is able to be performed by an external input operation.

20. The image display apparatus according to claim 17, further comprising:
determining means that determines nature of an input image on the basis of an input image signal, wherein
switching between output of the first signal generating means and output of the second signal generating means is performed according to a result of the determination performed by the determining means.

21. The image display apparatus according to claim 20, wherein
the determining means is moving/still image determining means that determines whether the input image is a moving image or a still image.

22. The image display apparatus according to claim 21, wherein
when the input image is determined as a moving image, the output of the first signal generating means is supplied as the display image signal to the display section, and
when the input image is determined as a still image, the output of the second signal generating means is supplied as the display image signal to the display section.

23. The image display apparatus according to claim 20, wherein
the determining means is luminance measuring means that measures average luminance of the input image.

24. The image display apparatus according to claim 23, wherein
when the average luminance of the input image is determined as being low, the output of the first signal generating means is supplied as the display image signal to the display section, and
when the average luminance of the input image is determined as being high, the output of the second signal generating means is supplied as the display image signal to the display section.

25. The image display apparatus according to claim 20, wherein
the determining means is frame frequency measuring means that measures frame frequency of the input image.

26. The image display apparatus according to claim 25, wherein
when the frame frequency of the input image is determined as being high, the output of the first signal generating means is supplied as the display image signal to the display section, and
when the frame frequency of the input image is determined as being low, the output of the second signal generating means is supplied as the display image signal to the display section.

27. The image display apparatus according to claim 26, wherein
the switching means has a frame frequency threshold value set to be in a range from 50 Hz to 60 Hz, the frame frequency threshold value being a criterion for switching between output of the first signal generating means and output of the second signal generating means.

28. The image display apparatus according to claim 17, further comprising:
image source determining means that determines a supply source of the input image,
wherein
the switching means switches between the output of the first signal generating means and the output of the second signal generating means according to a result of the determination performed by the image source determining means.

29. The image display apparatus according to claim 20, wherein
the determining means determines the nature of the input image for each of pixels on the basis of the input image signal, and
switching between the output of the first signal generating means and the output of the second signal generating means is performed for each of the pixels according to a result of the determination performed by the determining means.

30. The image display apparatus according to claim 29, wherein
the determining means is moving/still image determining means that determines for each of pixels whether the pixel corresponds to a moving image or a still image on the basis of the input image, wherein
for a pixel which is determined as corresponding to a moving image on the basis of the input image, the output of the first signal generating means is outputted as the display image signal to the display section, and for a pixel which is determined as corresponding to a still image on the basis of the input image, the output of the second signal generating means is outputted as the display image signal to the display section.

31. The image display apparatus according to claim 29, wherein
the determining means is luminance measuring means that measures luminance of each of pixels in the input image, wherein
for a pixel of which luminance is determined as being low in the input image, the output of the first signal generating means is supplied as the display image signal to the display section, and for a pixel of which luminance is determined as being high in the input image, the output of the second signal generating means is supplied as the display image signal to the display section.

32. The image display apparatus according to claim 17, wherein
the determining means determines the nature of the input image for each of sub-areas on the basis of the input image signal, and
switching between the output of the first signal generating means and the output of the second signal generating means is performed for each of the sub-areas according to a result of the determination performed by the determining means.

33. The image display apparatus according to claim 32, wherein
the determining means is moving/still image determining means that determines for each of sub-areas whether a sub-area corresponds to a moving image or a still image on the basis of the input image, and
for a sub-area which is determined as corresponding to a moving image on the basis of the input image, the output of the first signal generating means is supplied as the display image signal to the display section, and for a sub-area which is determined as corresponding to a still image on the basis of the input image, the output of the second signal generating means is supplied as the display image signal to the display section.

34. The image display apparatus according to claim 32, wherein
the determining means is luminance measuring means that measures luminance of each of sub-areas in the input image, and
for a sub-area of which average luminance is determined as being low in the input image, the output of the first signal generating means is supplied as the display image signal to the display section, and for a sub-area of which average luminance is determined as being high in the input image, the output of the second signal generating means is supplied as the display image signal to the display section.

35. An image display monitor comprising:
an image display apparatus according to claim 1; and
a signal input section for transmitting an external input image signal to the image display apparatus.

36. A television receiver comprising an image display apparatus according to claim 1.
